(19) United States
(12) Patent Application Publication
(10) Pub. No.: US 2025/0321401 A1
(43) Pub. Date: Oct. 16, 2025

(54) IMAGING OPTICAL SYSTEM

(71) Applicant: SIGMA CORPORATION, Kanagawa (JP)

(72) Inventor: Daichi TANOUE, Kanagawa (JP)

(73) Assignee: SIGMA CORPORATION, Kanagawa (JP)

(21) Appl. No.: 19/083,714

(22) Filed: Mar. 19, 2025

(30) Foreign Application Priority Data
Apr. 16, 2024 (JP) 2024-066116

(51) Int. Cl. G02B 9/64

(52) U.S. Cl. CPC G02B 9/64

(57) ABSTRACT

An imaging optical system is suitable for a telephoto lens having a large aperture ratio, is lightweight and longitudinal chromatic aberration is satisfactorily corrected. The imaging optical system includes, in order from an object side, a first lens group G1 that has a positive refractive power, a second lens group G2, and a third lens group G3. Only the second lens group G2 moves while focusing from an infinite distance object to a close distance object. The first lens group G1 includes a group 1a and a group 1b in order from the object side. The group 1b has a negative lens L1na having a meniscus shape that is convex toward the object side and a negative lens L1nb different from the negative lens L1na. The negative lens L1na is a negative lens positioned closest to the object side in the first lens group G1, and satisfies predetermined conditional expressions.

### TECHNICAL FIELD

The present invention relates to an imaging optical system suitable for an imaging lens used in a digital camera, a video camera, or the like.

### BACKGROUND ART

In recent years, digital cameras have been made lighter and higher in pixel count of image sensors due to the mirrorless technology. Therefore, even in the imaging optical system, it is required to be lightweight and high performance.

In particular, in a case of a telephoto lens with a large aperture ratio having a long focal length and a large aperture ratio, since the effective diameter is large and the lens diameter disposed on the object side is also large, the weight of the imaging optical system is likely to increase. Therefore, it is desired to further reduce the weight. As a method of reducing the weight of the telephoto lens with a large aperture ratio, the number of lenses having a large effective diameter disposed on the object side is reduced.

In addition, in a telephoto lens with a large aperture ratio, since the focal length is generally long and the aperture ratio is large, longitudinal chromatic aberration is likely to occur. It is known that in order to correct longitudinal chromatic aberration, it is effective to increase the number of lenses disposed on the object side.

### RELATED ART DOCUMENTS

### Patent Documents

[Patent Document 1] Japanese Patent No. 6627313
[Patent Document 2] Japanese Patent No. 6847067

### SUMMARY OF THE INVENTION

### Problem that the Invention is to Solve

In Patent Document 1 and Patent Document 2, longitudinal chromatic aberration is satisfactorily corrected. However, a negative lens closest to the object side in the first lens group, which corrects longitudinal chromatic aberration, has a large effective ray diameter with respect to the entrance pupil diameter, and there is a problem in achieving reduction in lens diameter. In addition, since the negative lens has a concave surface facing the object side, there is a problem that the weight of the glass material of the entire optical system is heavy due to an increase in the diameter of the subsequent lens due to an effect of diffusing the luminous flux.

The present invention has been made in view of such circumstances, and an object of the present invention is to provide an imaging optical system suitable for a telephoto lens having a large aperture ratio, which is light in weight and in which longitudinal chromatic aberration is satisfactorily corrected.

### Means for Solving the Problem

The imaging optical system according to the present invention includes, in order from an object side, a first lens group G1 that has a positive refractive power, a second lens group G2, and a third lens group G3, in which only the second lens group G2 moves while focusing from an infinite distance object to a close distance object, the first lens group G1 includes a group 1a and a group 1b in order from the object side, the group 1b has a negative lens L1na having a meniscus shape that is convex toward the object side and a negative lens L1nb different from the negative lens L1na, the negative lens L1na is a negative lens positioned closest to the object side in the first lens group G1, and the following conditional expressions are satisfied.

$$nL 1 nb > 1.73 \qquad ( 1 )$$

$$VdL 1 nb < 35 \qquad ( 2 )$$

$$Δ PgFL 1 nb < 0.013 \qquad ( 3 )$$

nL1nb: refractive index of the negative lens L1nb
VdL1nb: Abbe number of the negative lens L1nb
ΔPgFL1nb: anomalous dispersion of the negative lens L1nb

$$Δ PgFL 1 nb = PgFL 1 nb + 0.0018 \times VdL 1 nb - 0.64833$$

PgFL1nb is a partial dispersion ratio PgF of the negative lens L1nb with respect to a g line and an F line.

### Advantage of the Invention

According to the imaging optical system according to the present invention, it is possible to provide an imaging optical system suitable for a telephoto lens having a large aperture ratio, which is lightweight and in which longitudinal chromatic aberration is satisfactorily corrected.

### BRIEF DESCRIPTION OF THE DRAWINGS

FIG. 1 is a lens configuration diagram according to Example 1 of an imaging optical system of the present invention.

FIG. 2 is a longitudinal aberration diagram of the imaging optical system of Example 1 at an infinite photographing distance.

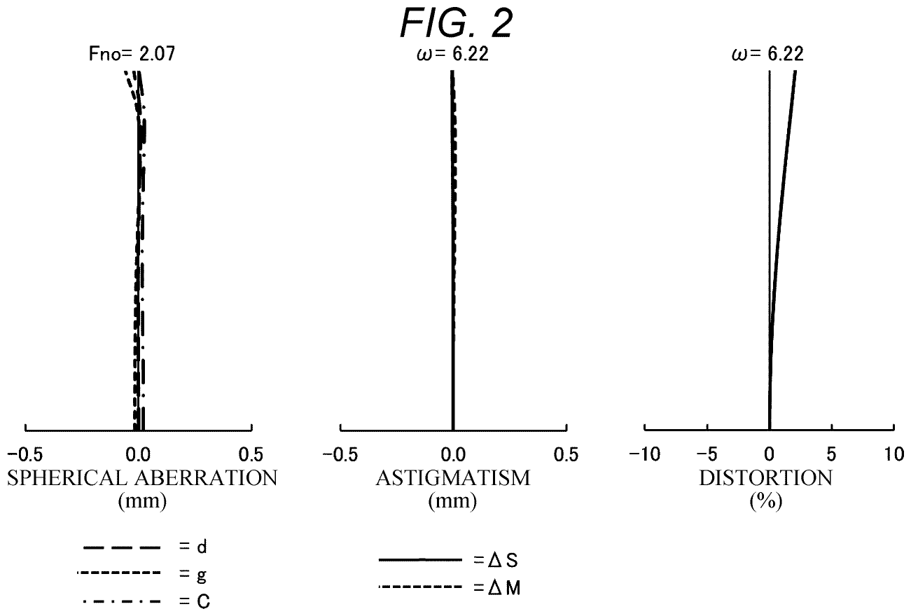

FIG. 3 is a longitudinal aberration diagram at a focusing distance of 1.7 m of the imaging optical system of Example 1.

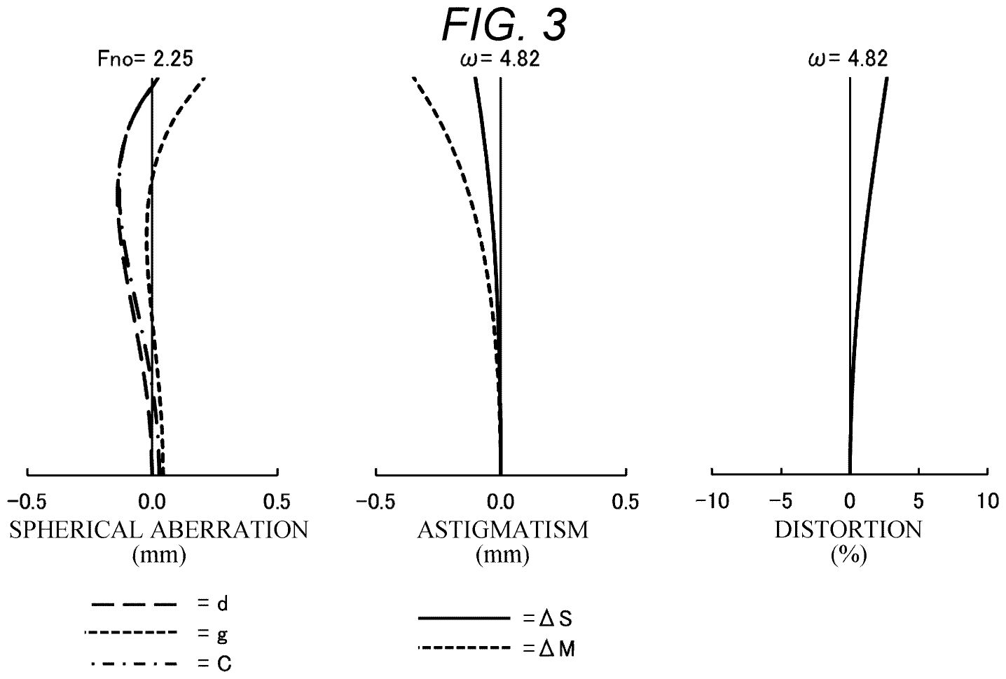

FIG. 4 is a lateral aberration diagram at an infinite photographing distance of the imaging optical system of Example 1.

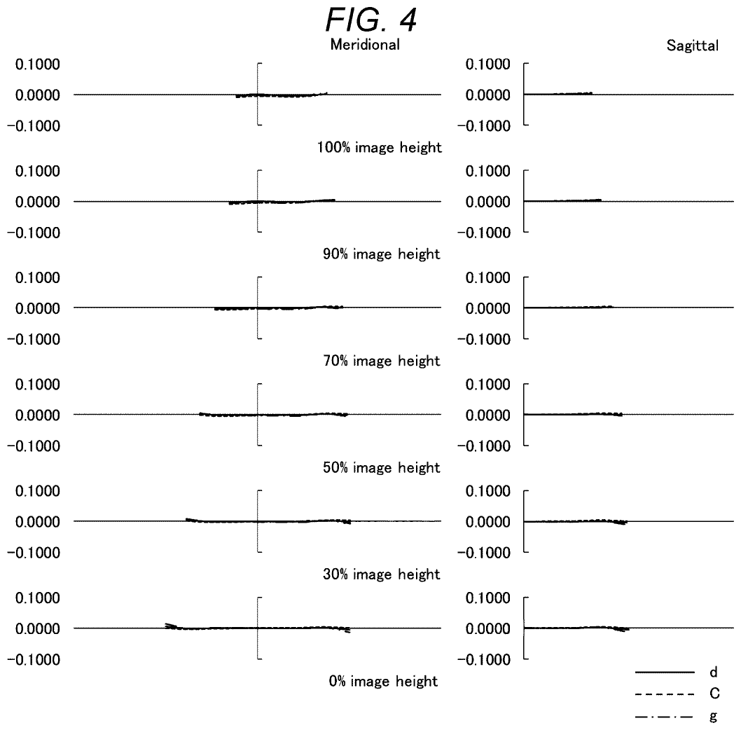

FIG. 5 is a lateral aberration diagram at a focusing distance of 1.7 m of the imaging optical system of Example 1.

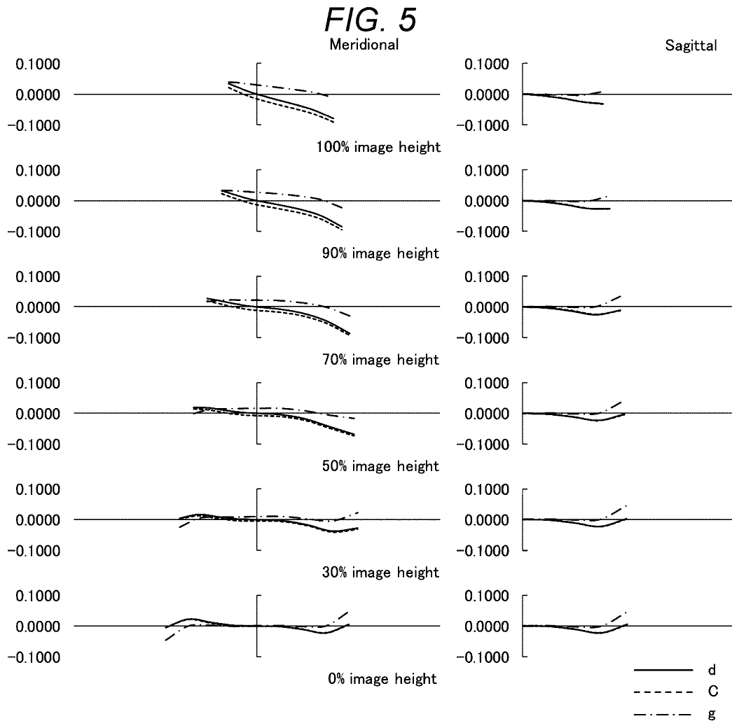

FIG. 6 is a lateral aberration diagram at 0.3° in the case of the vibration reduction at infinity of Example 1.

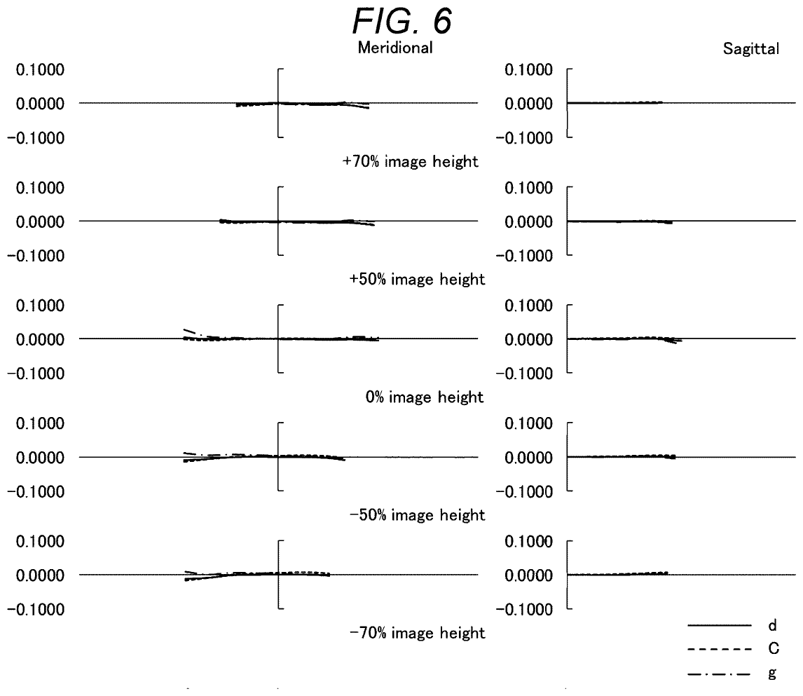

FIG. 7 is a lens configuration diagram according to Example 2 of the imaging optical system of the present invention.

FIG. 8 is a longitudinal aberration diagram of the imaging optical system of Example 2 at an infinite photographing distance.

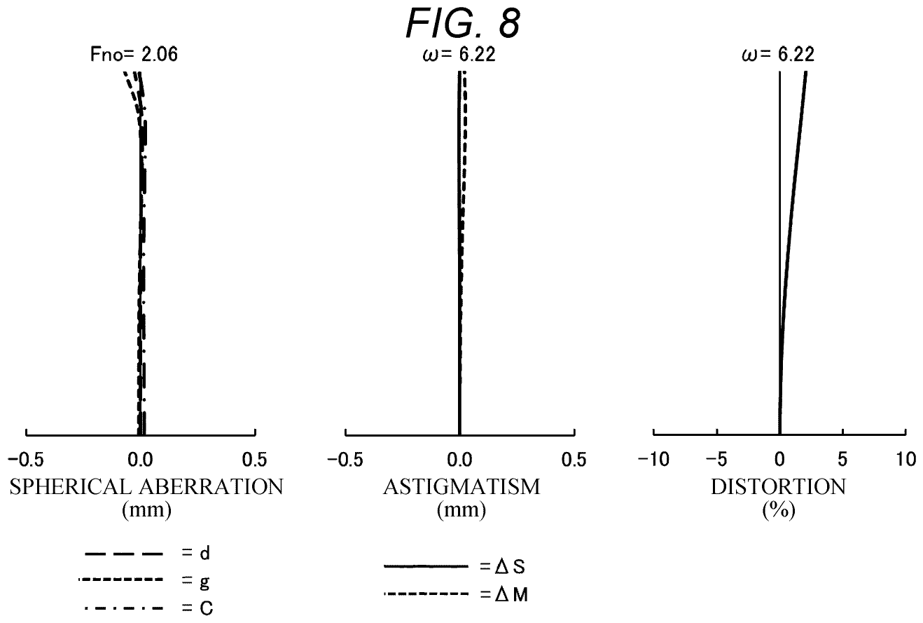

FIG. 9 is a longitudinal aberration diagram at a focusing distance of 1.7 m of the imaging optical system of Example 2.

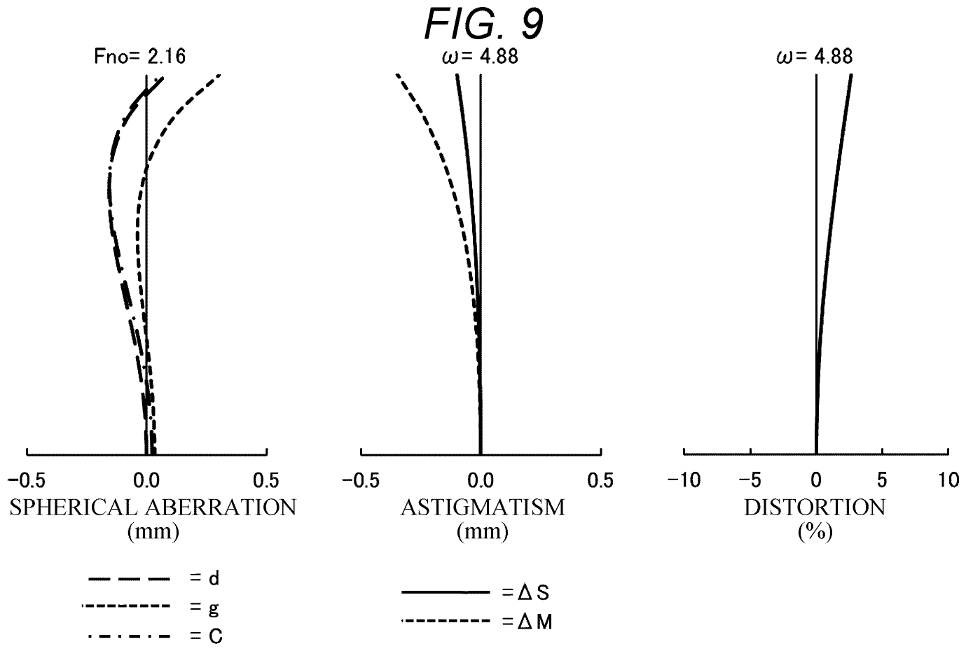

FIG. 10 is a lateral aberration diagram at an infinite photographing distance in the imaging optical system of Example 2.

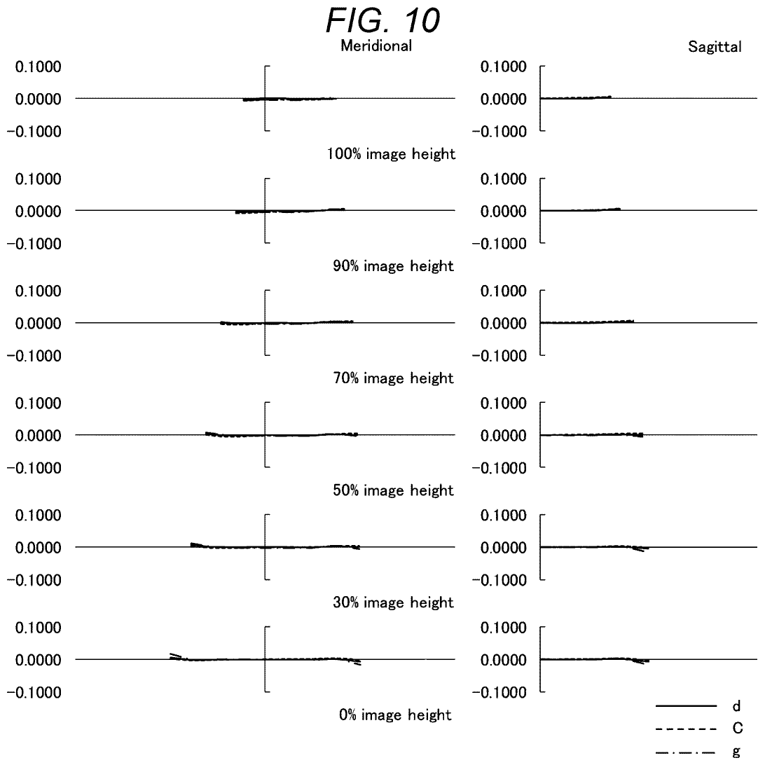

FIG. 11 is a lateral aberration diagram at a focusing distance of 1.7 m of the imaging optical system of Example 2.

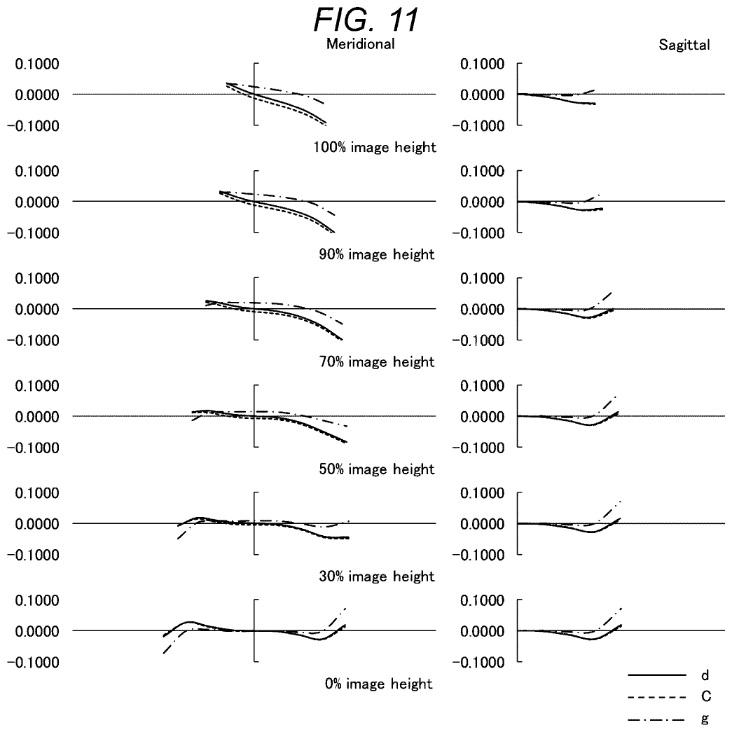

FIG. 12 is a lateral aberration diagram at 0.3° in the case of the vibration reduction at infinity of Example 2.

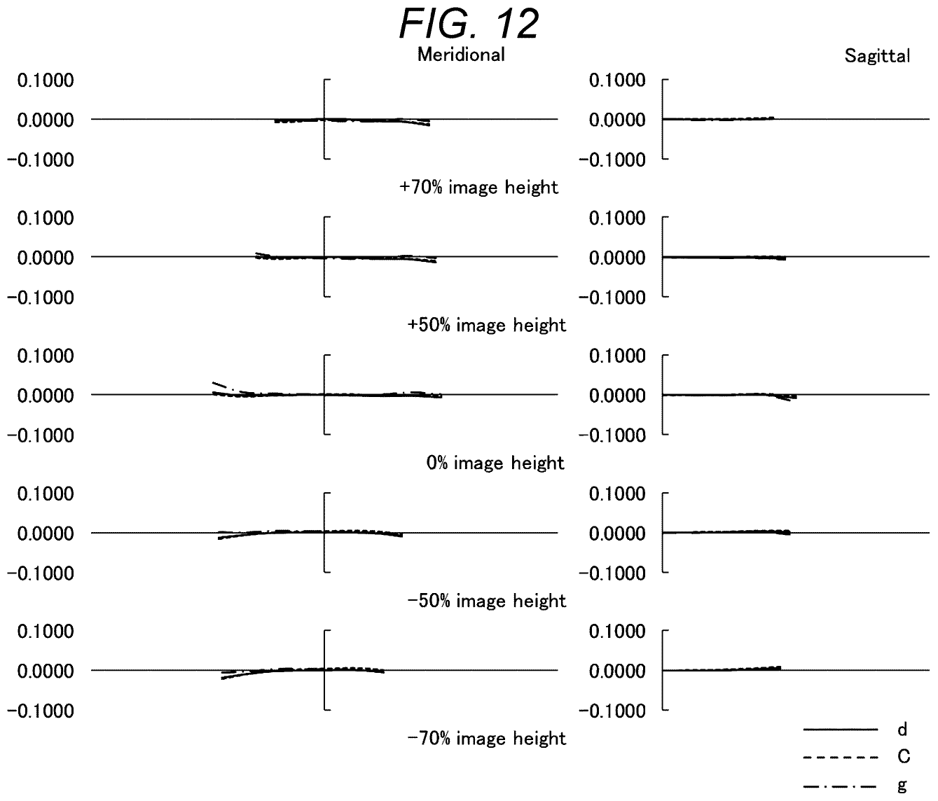

FIG. 13 is a lens configuration diagram according to Example 3 of the imaging optical system of the present invention.

FIG. 14 is a longitudinal aberration diagram of the imaging optical system of Example 3 at an infinite photographing distance.

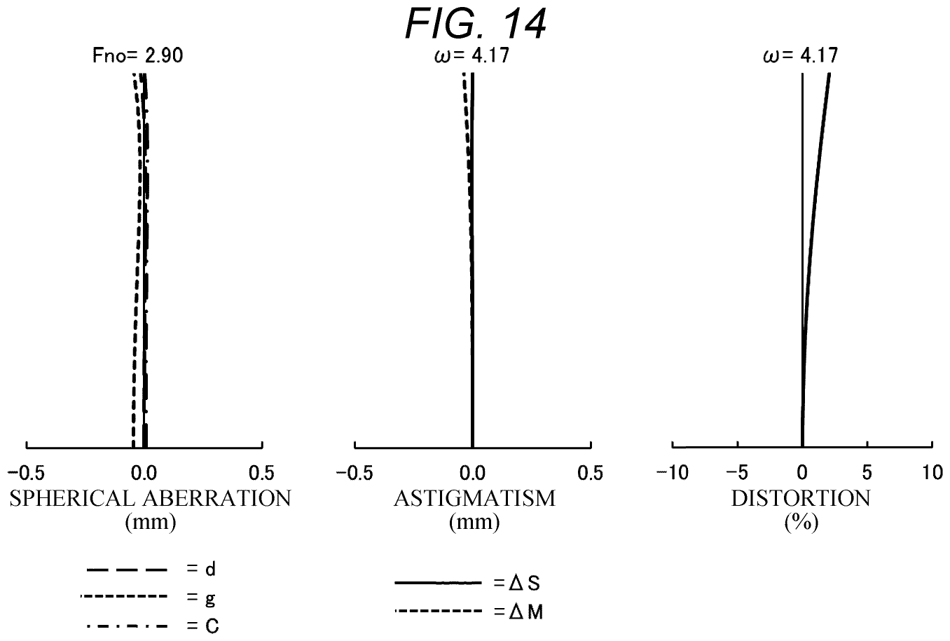

FIG. 15 is a longitudinal aberration diagram at a focusing distance of 2.0 m of the imaging optical system of Example 3.

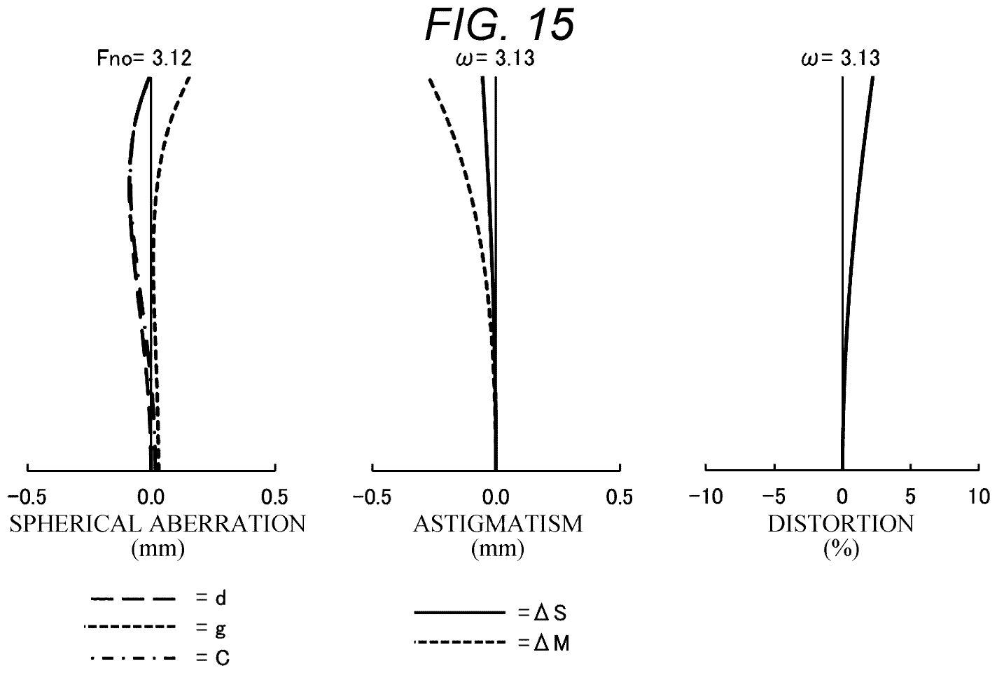

FIG. 16 is a lateral aberration diagram at an infinite photographing distance in the imaging optical system of Example 3.

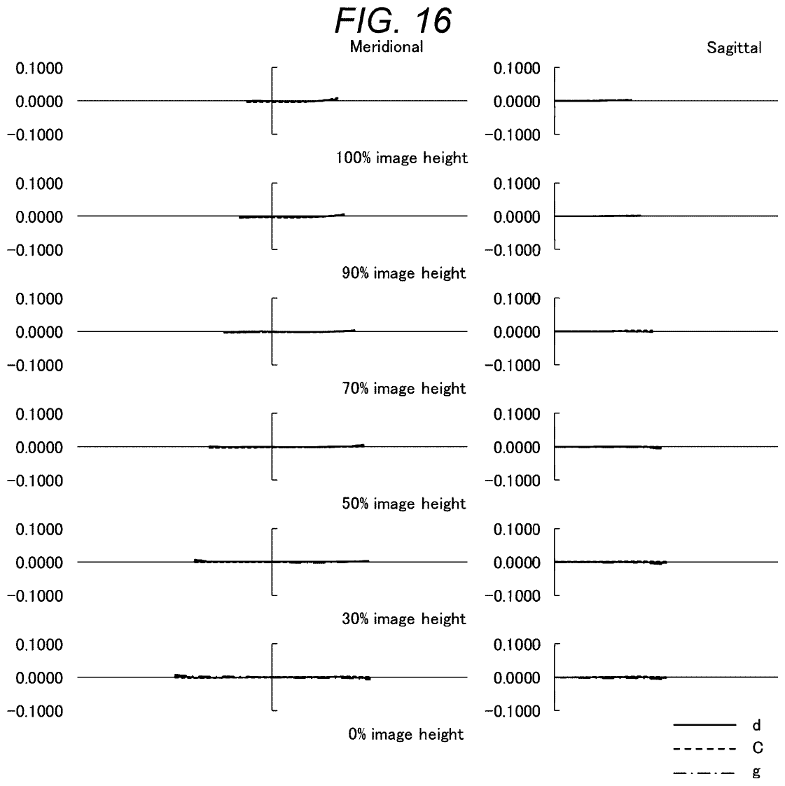

FIG. 17 is a lateral aberration diagram at a focusing distance of 2.0 m of the imaging optical system of Example 3.

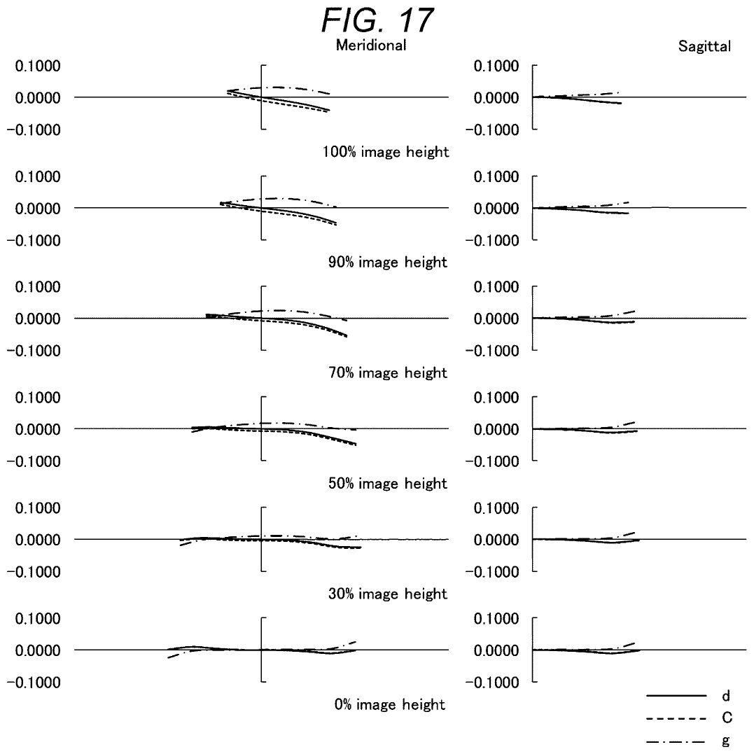

FIG. 18 is a lateral aberration diagram at 0.3° in the case of the vibration reduction at infinity of Example 3.

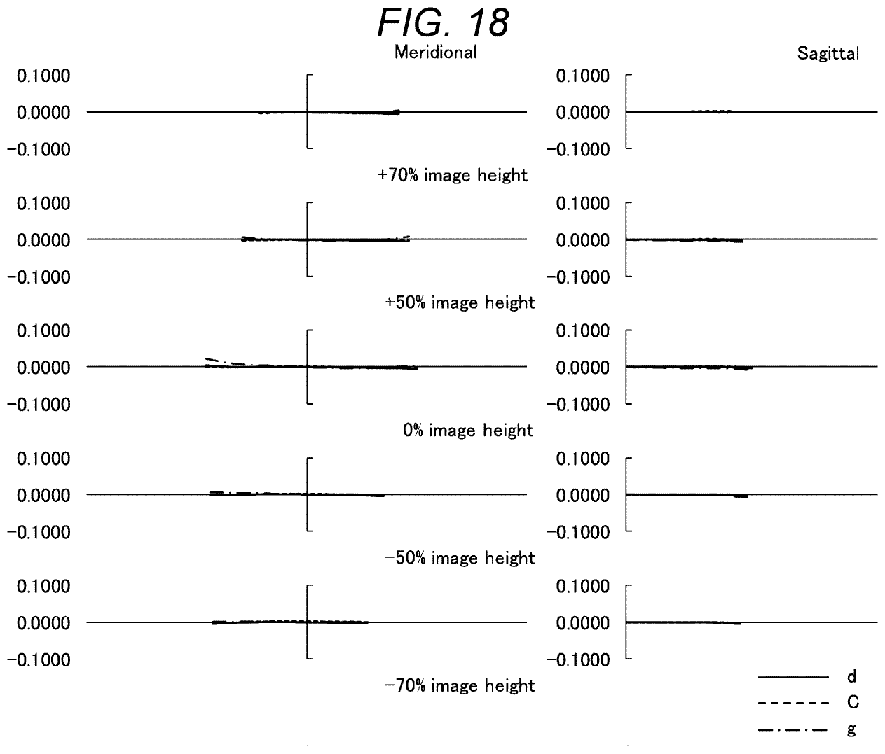

FIG. 19 is a lens configuration diagram according to Example 4 of the imaging optical system of the present invention.

FIG. 20 is a longitudinal aberration diagram of the imaging optical system of Example 4 at an infinite photographing distance.

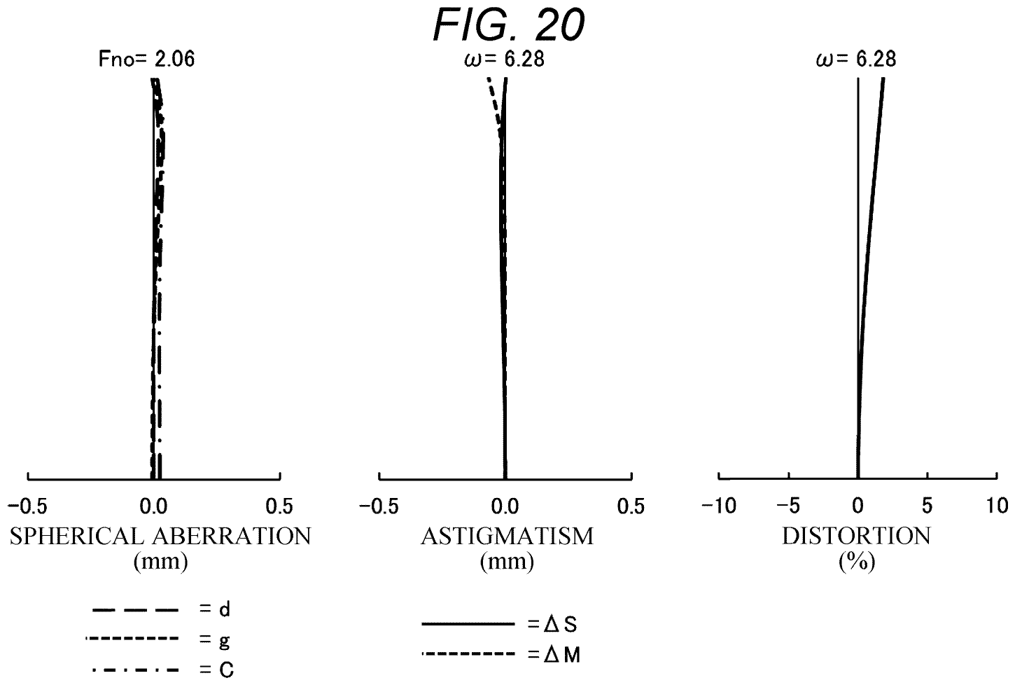

FIG. 21 is a longitudinal aberration diagram of the imaging optical system of Example 4 at a focusing distance of 1.9 m.

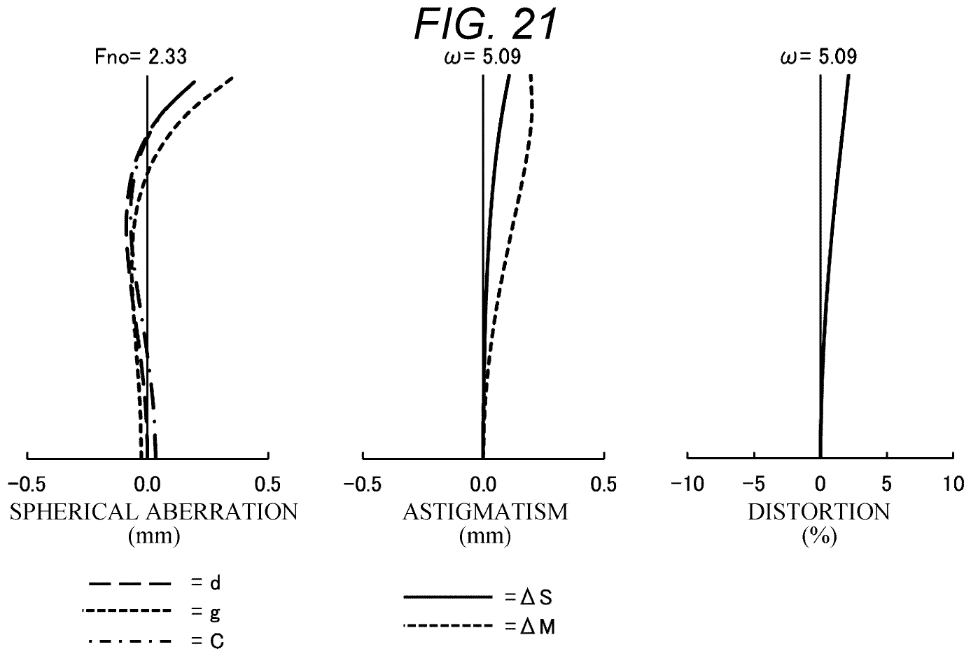

FIG. 22 is a lateral aberration diagram at an infinite photographing distance in the imaging optical system of Example 4.

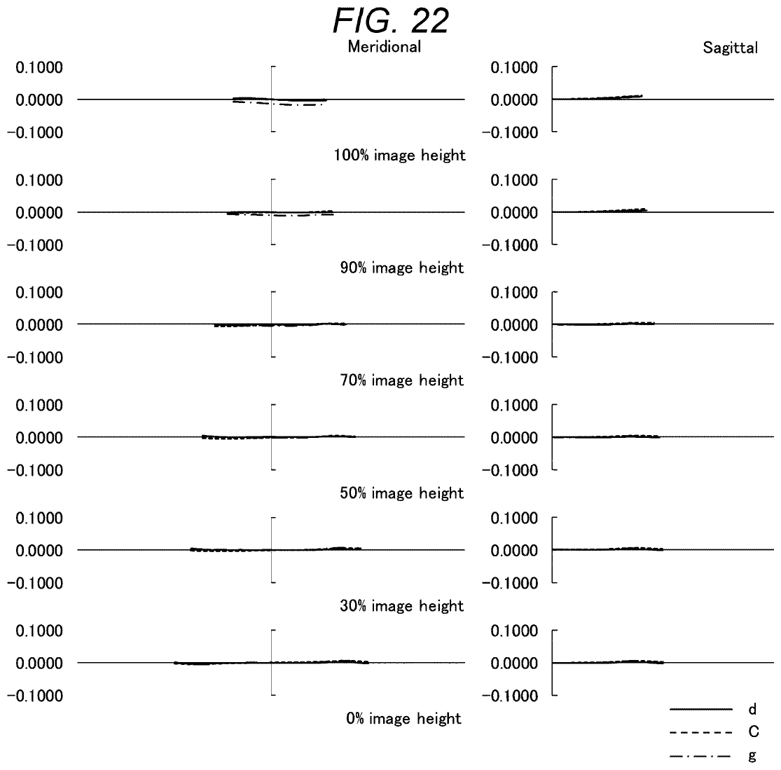

FIG. 23 is a lateral aberration diagram of the imaging optical system of Example 4 at a focusing distance of 1.9 m.

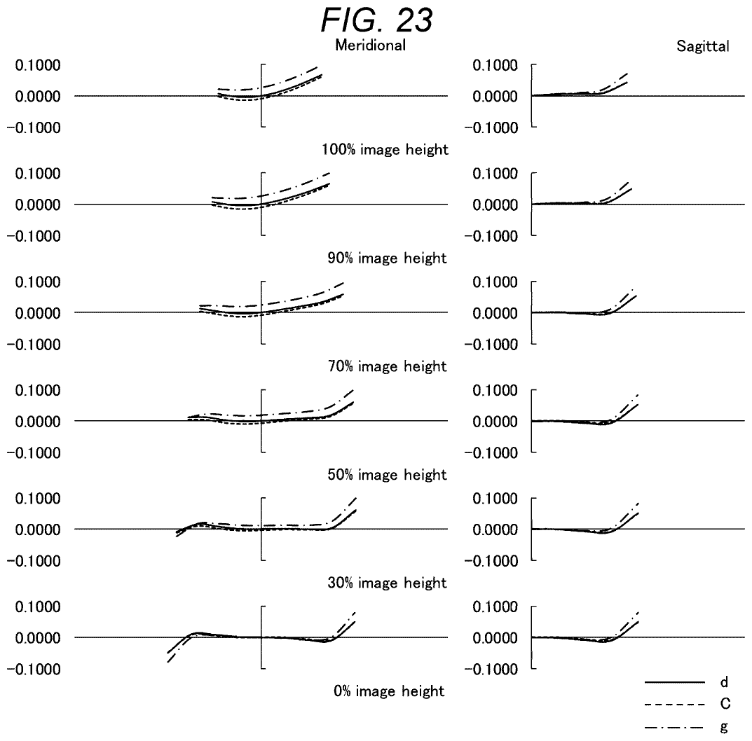

FIG. 24 is a lateral aberration diagram at 0.3° in the case of the vibration reduction at infinity of Example 4.

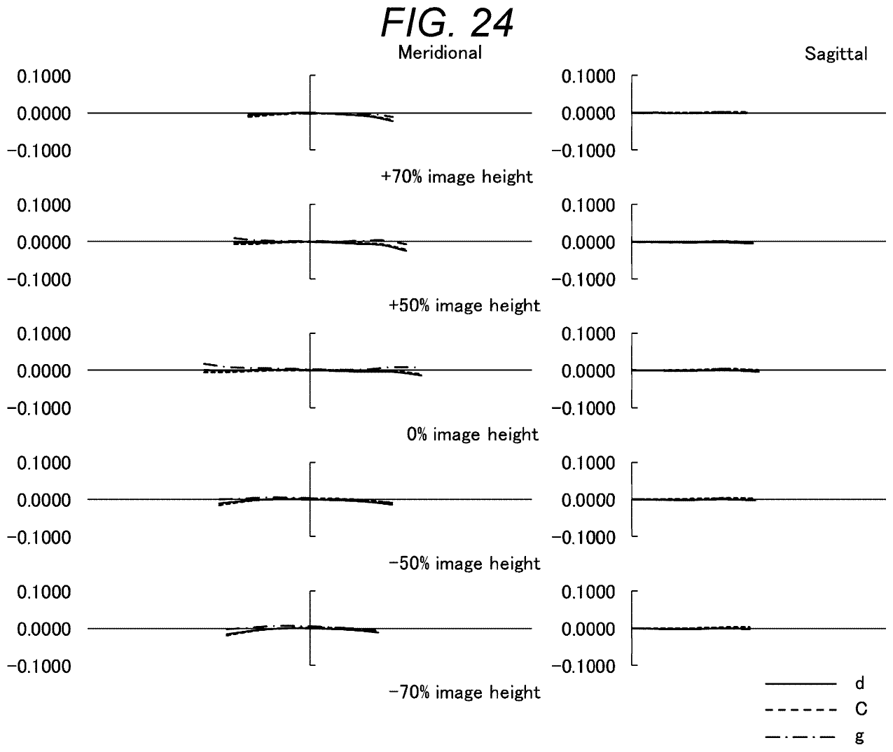

FIG. 25 is a lens configuration diagram according to Example 5 of the imaging optical system of the present invention.

FIG. 26 is a longitudinal aberration diagram of the imaging optical system of Example 5 at an infinite photographing distance.

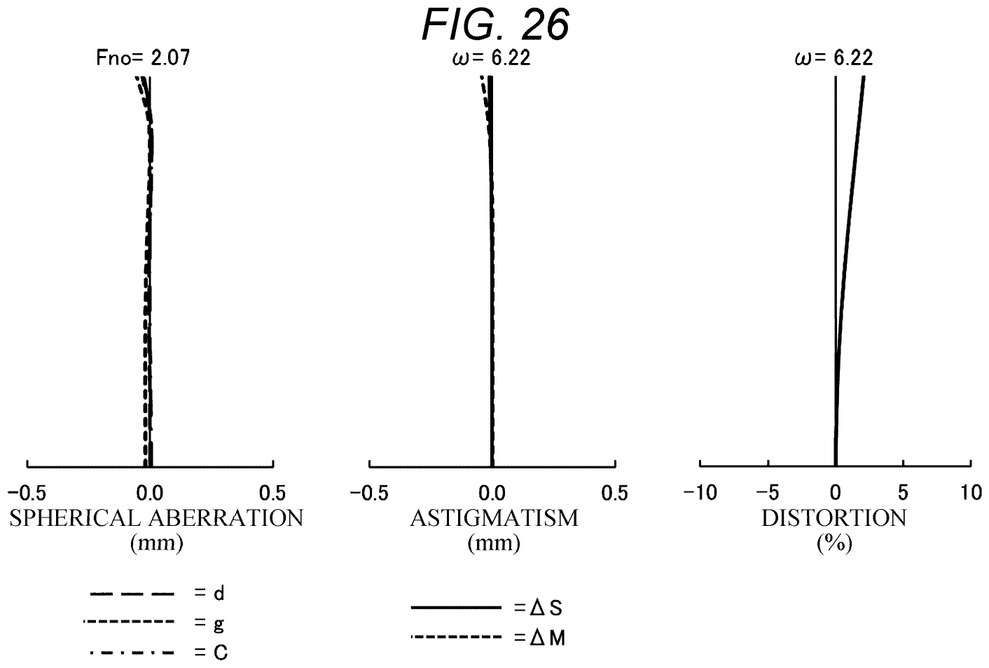

FIG. 27 is a longitudinal aberration diagram of the imaging optical system of Example 5 at a focusing distance of 1.7 m.

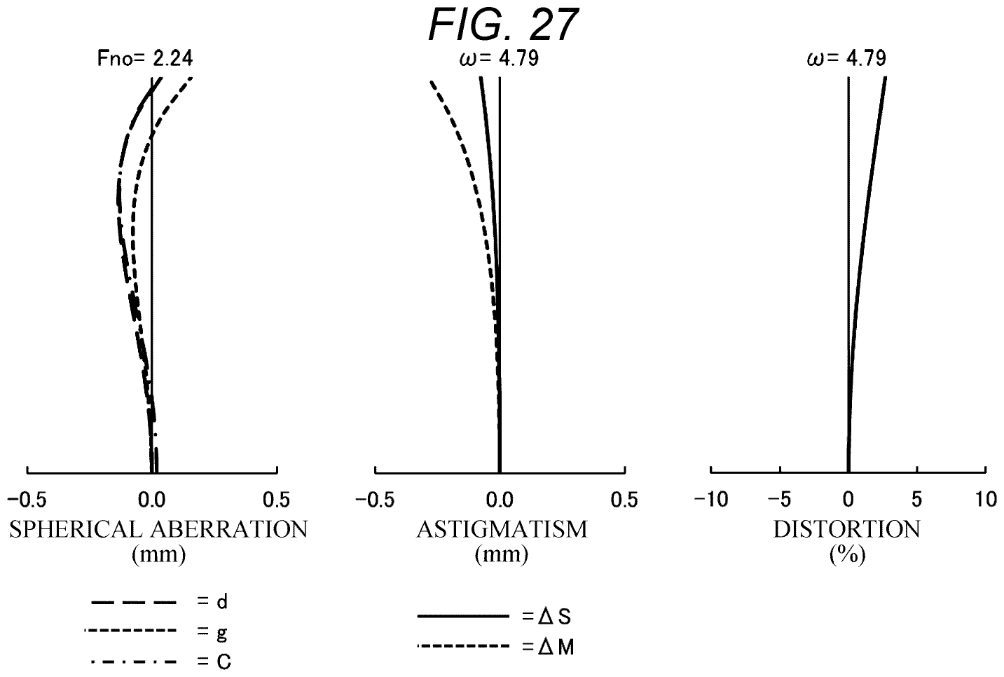

FIG. 28 is a lateral aberration diagram at an infinite photographing distance in the imaging optical system of Example 5.

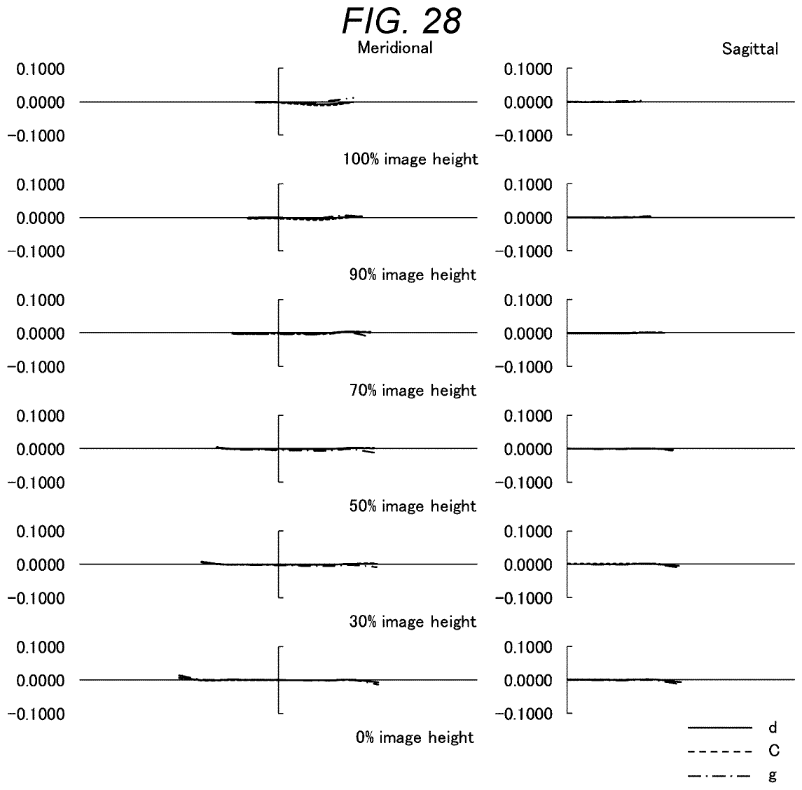

FIG. 29 is a lateral aberration diagram at a focusing distance of 1.7 m in the imaging optical system of Example 5.

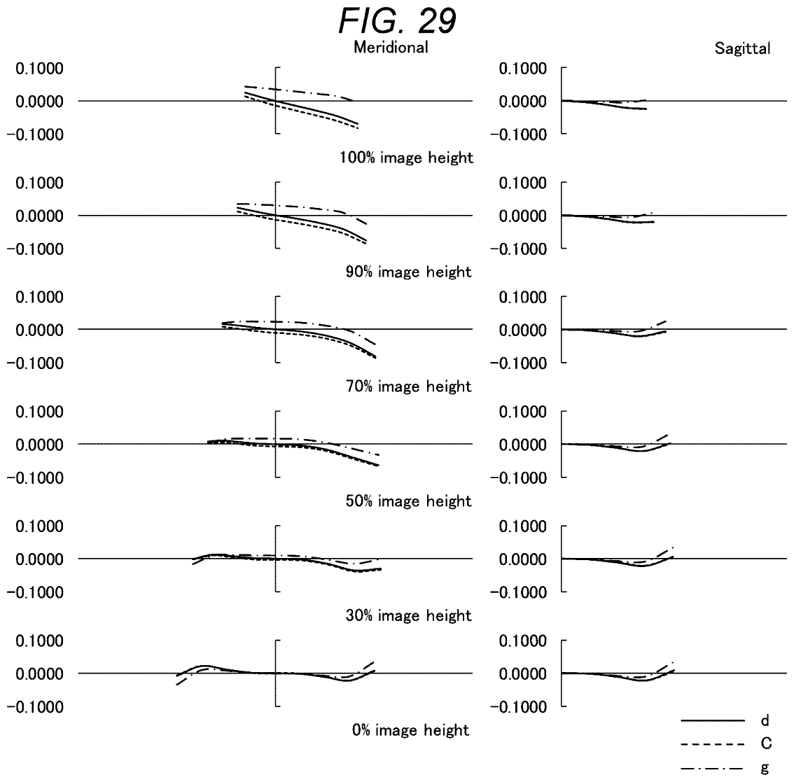

FIG. 30 is a lateral aberration diagram at 0.3° in the case of the vibration reduction at infinity in Example 5.

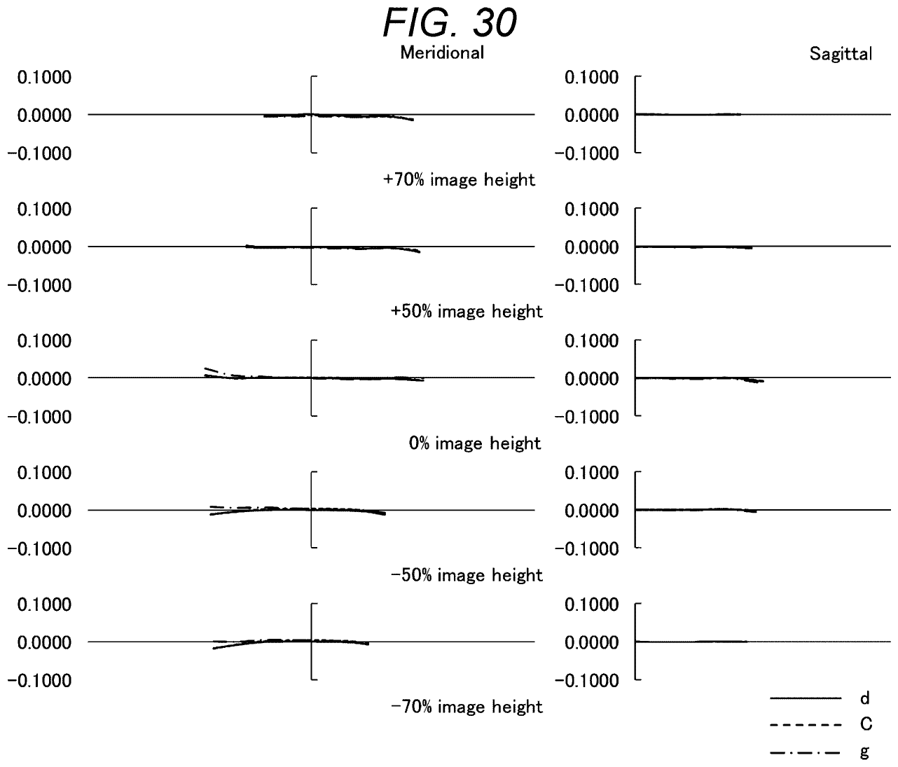

FIG. 31 is a lens configuration diagram according to Example 6 of the imaging optical system of the present invention.

FIG. 32 is a longitudinal aberration diagram of the imaging optical system of Example 6 at an infinite photographing distance.

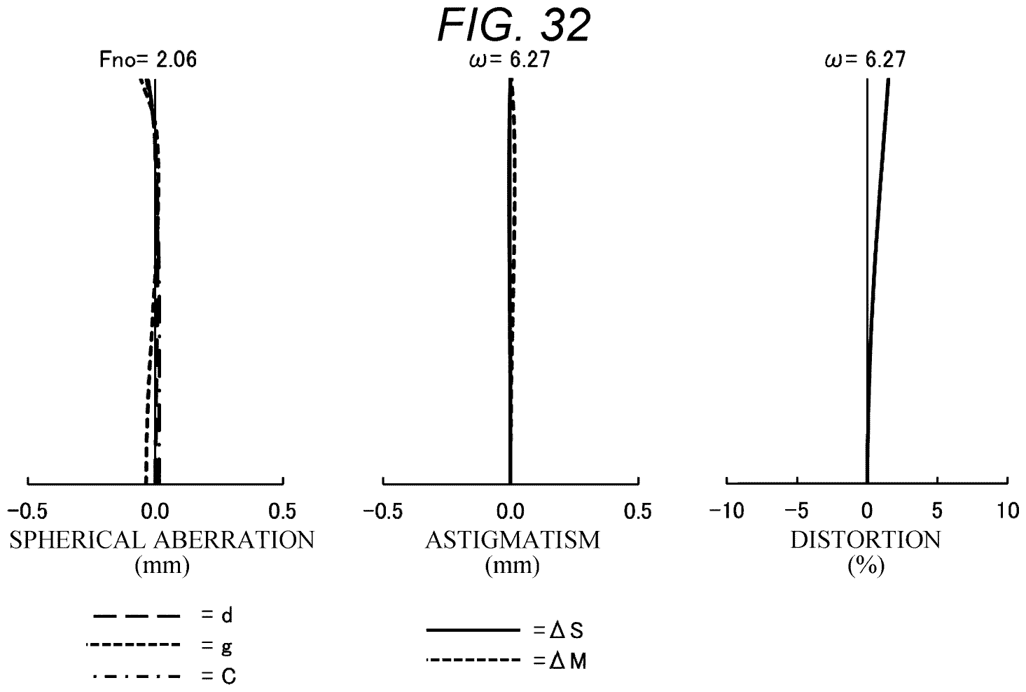

FIG. 33 is a longitudinal aberration diagram of the imaging optical system of Example 6 at a focusing distance of 1.8 m.

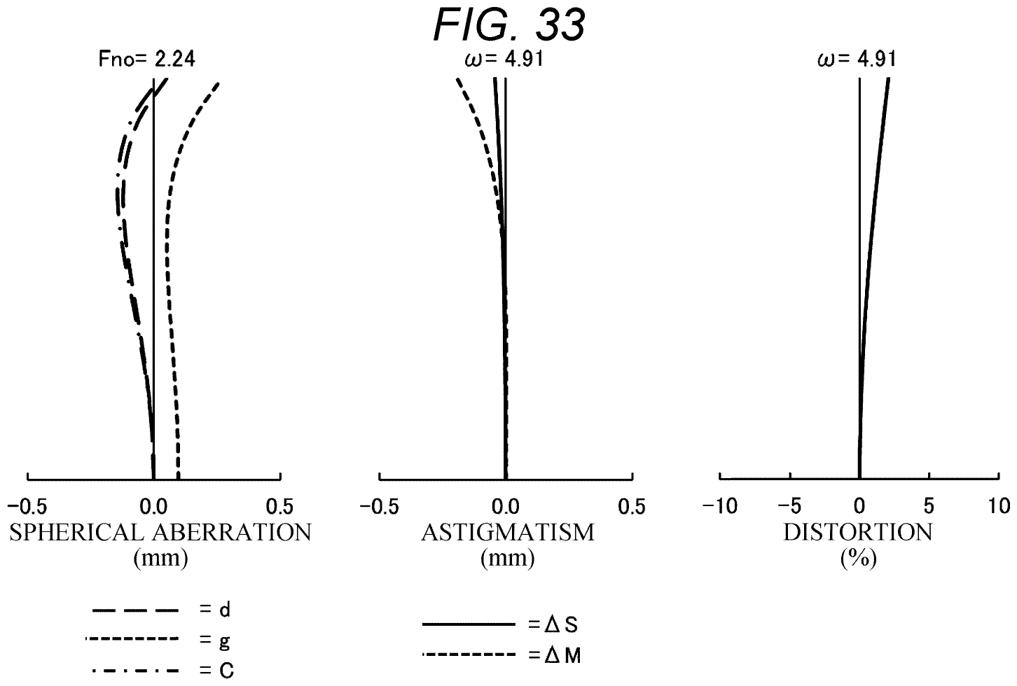

FIG. 34 is a lateral aberration diagram of the imaging optical system of Example 6 at an infinite photographing distance.

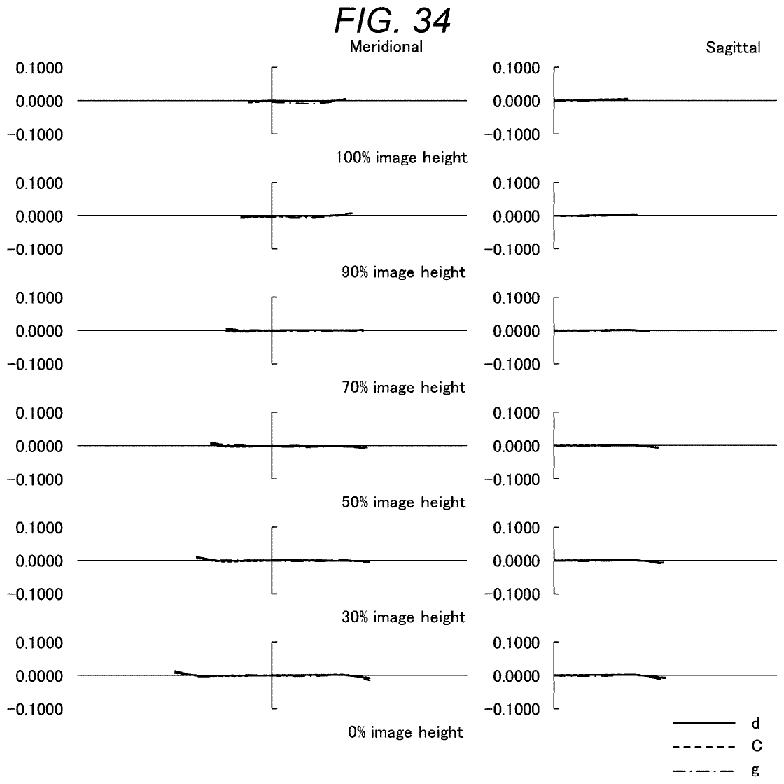

FIG. 35 is a lateral aberration diagram at a focusing distance of 1.8 m in the imaging optical system of Example 6.

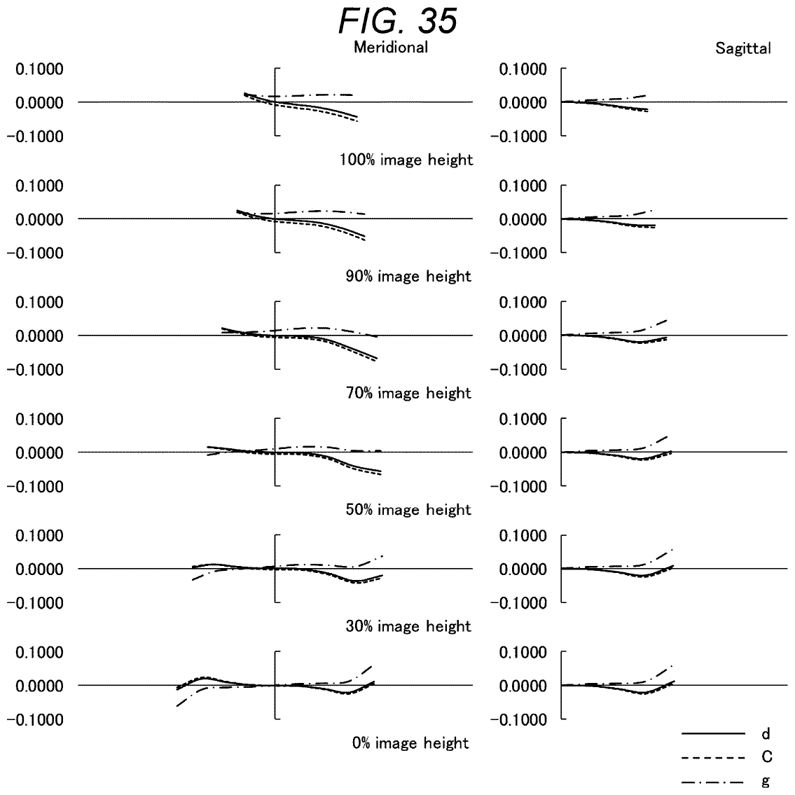

FIG. 36 is a lateral aberration diagram at 0.3° in the case of the vibration reduction at infinity in Example 6.

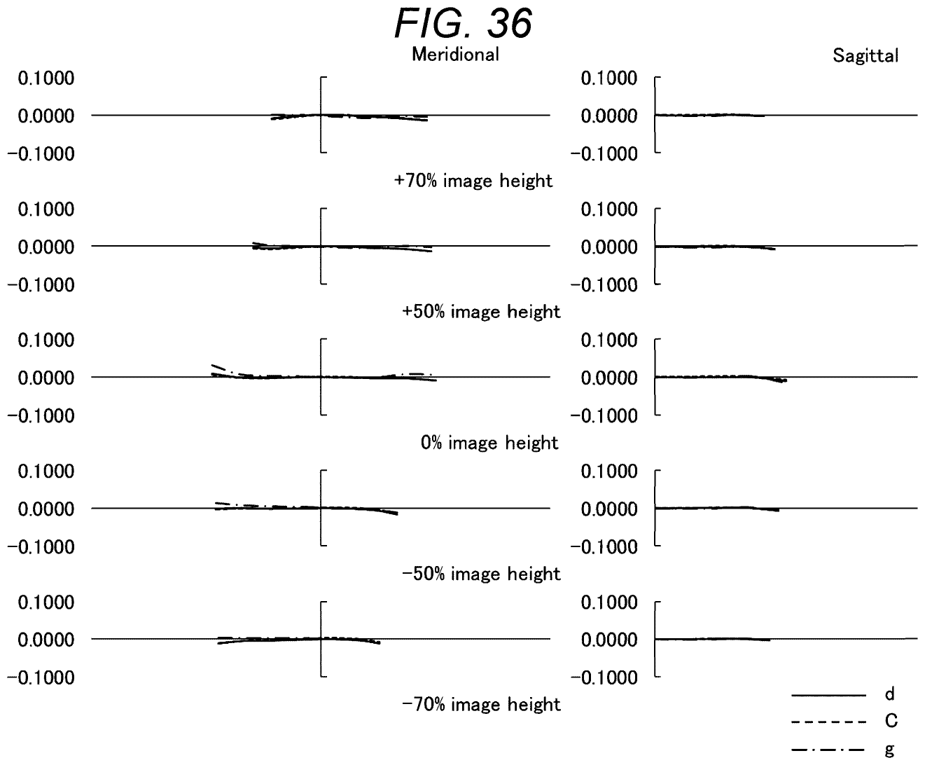

### EMBODIMENTS OF THE INVENTION

Hereinafter, embodiments of the present invention will be described with reference to the accompanying drawings. In the description of the embodiments of the present invention, a case where a lens is simply described refers to a single lens portion that constitutes a single lens or a cemented lens. In addition, the cemented lens refers to a lens in which a plurality of single lenses are cemented.

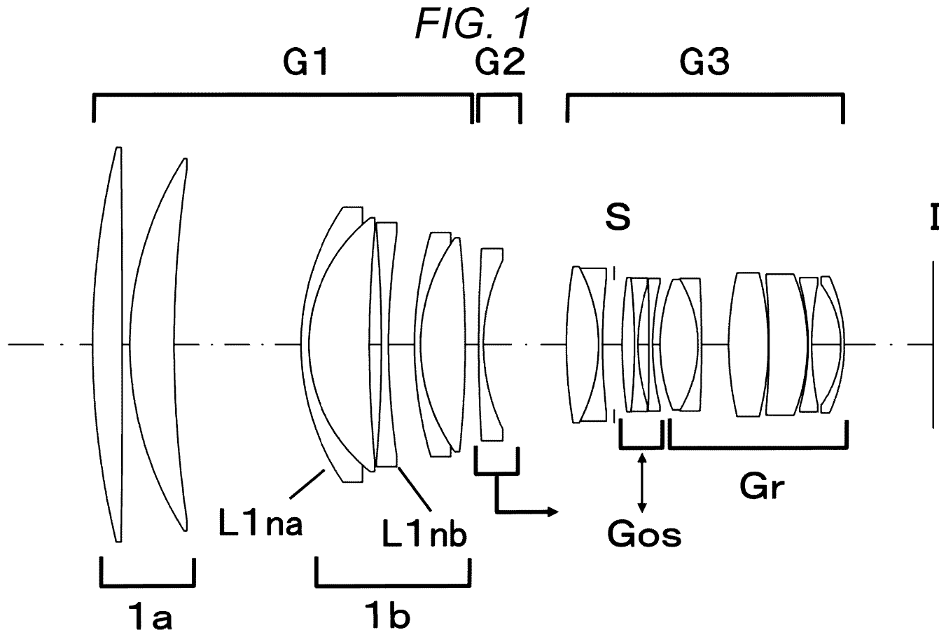

As shown in the lens configuration diagrams of FIGS. 1, 7, 13, 19, 25, and 31, the imaging optical system according to the present invention includes, in order from the object side, a first lens group G1 having a positive refractive power, a second lens group G2, and a third lens group G3, in which only the second lens group G2 moves along the optical axis while focusing from infinity to a short distance, the first lens group G1 includes a group 1a and a group 1b in order from the object side, the group 1b has a negative lens L1na having a meniscus shape that is convex toward the object side and a negative lens L1nb different from the negative lens L1na, the negative lens L1na is a negative lens positioned closest to the object side in the first lens group G1, and the following conditional expressions are satisfied.

$$nL 1 nb > 1.73 \qquad ( 1 )$$

$$VdL 1 nb < 35 \qquad ( 2 )$$

$$Δ PgFL 1 nb < 0.013 \qquad ( 3 )$$

nL1nb: refractive index of the negative lens L1nb
VdL1nb: Abbe number of the negative lens L1nb
ΔPgFL1nb: anomalous dispersion of the negative lens L1nb

$$Δ PgFL 1 nb = PgFL 1 nb + 0.0018 \times VdL 1 nb - 0.64833$$

PgFL1nb is a partial dispersion ratio PgF of the negative lens with respect to a g line and an F line.

By setting the first lens group G1 to have a positive refractive power, the rays can be converged, and the second lens group G2, which is the focus group, can be reduced in diameter. In addition, by reducing the diameter of the focus group which is a movable group, the weight is reduced, and the actuator which moves the focus group can also be reduced in weight.

Further, a negative lens L1na that is closest to the object side among the negative lenses in the first lens group G1 and that has a meniscus shape that is convex toward the object side is disposed in the group 1b. As a result, the rays are converged by the convex surface on the object side while the ray height of the first surface of the negative lens L1na is decreased, and the diameter of the incident luminous flux on the subsequent lens surface is decreased, and thus the weight can be reduced. In addition, since the negative lens L1na has a negative refractive power, it is possible to suppress the occurrence of longitudinal chromatic aberration.

In the imaging optical system according to the embodiment of the present invention, the first lens group G1 includes a cemented lens including a positive lens and a negative lens and having a positive refractive power. However, by reducing a difference in partial dispersion ratio between the positive lens and the negative lens included in the cemented lens, second-order chromatic aberration generated in the cemented lens is corrected. Furthermore, the negative lens L1nb corrects first-order chromatic aberration and various aberrations for a plurality of positive lenses of the first lens group G1, which include single lenses. Therefore, by disposing the negative lens L1nb having a high refractive index and high dispersion in the group 1b as specified by Conditional Expressions (1) and (2), it is possible to correct the first-order longitudinal chromatic aberration in the first lens group G1 including the group 1a while suppressing the occurrence of various aberrations. Further, by using the glass material in which the positive anomalous dispersion is suppressed as specified in Conditional Expression (3), it is easy to satisfactorily correct the longitudinal chromatic aberration including the second-order.

In a case where the refractive power of the negative lens L1nb is less than the lower limit of Conditional Expression (1), it is difficult to correct spherical aberration or comatic aberration.

In Conditional Expression (1), by setting the lower limit value to 1.80, the above-described effect can be made more reliable.

In a case where the dispersion of the negative lens L1nb is decreased below the lower limit of Conditional Expression (2), it is difficult to correct the longitudinal chromatic aberration.

In Conditional Expression (2), by limiting the lower limit value to 30, the above-described effect can be made more reliable.

In a case where the positive anomalous dispersion of the negative lens L1nb is increased beyond the upper limit of Conditional Expression (3), it is difficult to correct the second-order longitudinal chromatic aberration.

In regard to Conditional Expression (3), by desirably limiting the upper limit value thereof to 0.009, the above-described effect can be made more reliable.

Furthermore, in the imaging optical system according to the present invention, it is desirable that the group 1a has a positive refractive power and is composed of one positive lens or two positive lenses. By setting the group 1a to have a positive refractive power, a reduction in diameter of the group 1b and subsequent groups is achieved due to the convergence effect. In addition, by forming the group 1a with one or two positive lenses, it is easy to reduce the weight of the group 1a having a large effective aperture diameter.

Furthermore, in the imaging optical system according to the embodiment of the present invention, it is desirable that the first lens group G1 satisfies the following conditional expression.

$$D 1 / f > 0.08 \qquad ( 4 )$$

D1: maximum air spacing in first lens group G1
f: focal length of entire system at infinity focus

Conditional Expression (4) specifies a ratio of the maximum air spacing in the first lens group G1 to the focal length of the entire system. As can be seen from the lens configuration diagrams shown in FIGS. 1, 7, 13, 19, 25, and 31, the group 1a and the group 1b constituting the first lens group G1 are separated by the largest air spacing in the first lens group G1. By ensuring the maximum air spacing in the first lens group G1 so as to satisfy Conditional Expression (4), it is possible to sufficiently reduce the diameter of the luminous flux converged by the group 1a having a positive refractive power, and it is possible to reduce the diameter of the lens of the group 1b and subsequent groups, and to achieve reduction in weight.

In a case where the air spacing in the first lens group G1 is reduced below the lower limit of Conditional Expression (4), the diameter of the rays incident on the group 1b cannot be sufficiently reduced, and the lens diameter increases. Thus, it is difficult to reduce the weight.

In Conditional Expression (4), by desirably limiting the upper limit value to 0.26 and the lower limit value to 0.10, the above-described effect can be made more reliable.

Furthermore, it is desirable that the imaging optical system according to the aspect of the present invention satisfies the following conditional expressions.

$$0.4 < f 1 a / f < 1.7 \qquad ( 5 )$$

$$0.3 < R 1 na / EPD < 1.2 \qquad ( 6 )$$

fla: focal length of the group 1a
f: focal length of entire system at infinity focus
R1na: object side curvature radius of the negative lens L1na
EPD: entrance pupil diameter

Conditional Expression (5) specifies a ratio of the focal length of the group 1a to the focal length of the entire system at infinity focus. By satisfying Conditional Expression (5), there is an advantage in achieving reduction in weight of the imaging optical system and correcting various aberrations.

In a case where the focal length of the group 1a is increased beyond the upper limit of Conditional Expression (5), the convergence effect of the group 1a does not sufficiently work, and the lens diameters of the group 1b and subsequent groups cannot be reduced. Thus, it is difficult to reduce the weight.

In a case where the focal length of the group 1a is decreased below the lower limit of Conditional Expression (5), the refractive power of the group 1a is too strong, and thus spherical aberration and comatic aberration occur significantly, which makes it difficult to perform correction.

In Conditional Expression (5), by limiting the lower limit value to 0.6 and the upper limit value to 1.3, the above-described effect can be more reliably achieved.

Conditional Expression (6) specifies a ratio of the curvature radius of the negative lens L1na on the object side to the entrance pupil diameter, and is related to the refractive power of the object side surface of the negative lens L1na and the aberration correction ability. By satisfying Conditional Expression (6), there is an advantage in achieving reduction in weight of the imaging optical system and correcting various aberrations.

In a case where the curvature radius of the negative lens L1na on the object side is increased beyond the upper limit of Conditional Expression (6), the convergence effect on the object side surface of the negative lens L1na is weakened, and the lens diameter cannot be reduced thereafter. Therefore, it is difficult to reduce the weight.

In a case where the curvature radius of the negative lens L1na on the object side is decreased below the lower limit of Conditional Expression (6), the refractive power on the object side surface of the negative lens L1na is increased, and thus spherical aberration and comatic aberration are likely to occur, which makes correction difficult.

In Conditional Expression (6), by limiting the lower limit value to 0.5 and the upper limit value to 1.0, the above-described effect can be made more reliable.

Furthermore, in the imaging optical system according to the present invention, it is desirable that the negative lens L1na satisfies the following conditional expressions.

$$1.65 < nL 1 na < 1.8 \qquad ( 7 )$$

$$VdL 1 na > 40 \qquad ( 8 )$$

nL1na: refractive index of the negative lens L1na
VdL1na: Abbe number of the negative lens L1na

Conditional Expression (7) specifies a preferable range of the refractive index of the negative lens L1na. By satisfying Conditional Expression (7), there is an advantage in correcting various aberrations and reducing the weight of the imaging optical system.

In a case where the refractive index of the negative lens L1na exceeds the upper limit of Conditional Expression (7), it is difficult to correct comatic aberration or astigmatism.

In a case where the refractive index of the negative lens L1na is lower than the lower limit of Conditional Expression (7), it is difficult to correct the longitudinal chromatic aberration. In addition, since the convergence effect on the object side convex surface of the negative lens L1na is weakened, it is difficult to reduce the weight.

Regarding Conditional Expression (7), the above-described effect can be made more reliable by desirably limiting the lower limit value to 1.68 and the upper limit value to 1.76.

Conditional Expression (8) specifies a preferable range for the Abbe number of the negative lens L1na. By satisfying Conditional Expression (8), it is possible to satisfactorily correct longitudinal chromatic aberration.

In a case where the dispersion of the negative lens L1na is increased and the value of Conditional Expression (8) is decreased below the lower limit, it is difficult to correct the longitudinal chromatic aberration.

In Conditional Expression (8), by desirably limiting the lower limit value thereof to 45, the above-described effect can be made more reliable.

Furthermore, in the imaging optical system according to the present invention, it is desirable that the third lens group G3 has, in order from the object side, the vibration reduction group Gos having a negative refractive power and moving in a direction including a component perpendicular to the optical axis while image shake correction, and the positive refractive power rear group Gr. By disposing the vibration reduction group Gos in the third lens group, the diameter of the luminous flux passing through the vibration reduction group is reduced, and the vibration reduction mechanism can be reduced. In addition, since the rear group Gr having a positive refractive power is disposed on the image side of the vibration reduction group Gos, the negative refractive power of the vibration reduction group Gos can be increased. Therefore, it is possible to suppress the amount of movement during the vibration reduction.

In addition, it is desirable to satisfy the conditional expressions shown below.

$$- 1.5 < fGos / fGr < - 0.7 \qquad ( 9 )$$

fGos: focal length of the vibration reduction group Gos
fGr: focal length of the rear group Gr

Conditional Expression (9) specifies a ratio of the focal lengths of the vibration reduction group Gos and the rear group Gr. By satisfying Conditional Expression (9), there is an advantage in reducing fluctuation in aberrations during image stabilization and achieving reduction in size of the product.

In a case where the focal length of the vibration reduction group Gos is decreased and the value of Conditional Expression (9) is increased above the upper limit, the refractive power of the vibration reduction group Gos is excessively increased. Therefore, the fluctuation in the comatic aberration or the astigmatism is increased in a case where the vibration reduction group Gos is moved vertically during the vibration reduction.

In a case where the focal length of the vibration reduction group Gos is increased and the value of Conditional Expression (9) is decreased below the lower limit, the amount of movement required to correct camera shake during vibration reducing increases, and it is difficult to reduce the size of the entire product.

In Conditional Expression (9), by desirably limiting the lower limit value to −1.3 and the upper limit value to −0.8, the above-described effect can be made more reliable.

Furthermore, in the imaging optical system according to the embodiment of the present invention, it is desirable that the second lens group G2 includes a single lens or one cemented lens. Since the second lens group G2 is a focus group, the weight of the lens is reduced by using one lens or one cemented lens, and it is possible to reduce the weight of the actuator that moves the focus group.

Furthermore, in the imaging optical system according to the embodiment of the present invention, it is desirable that the imaging optical system is configured without including the diffractive optical element in the imaging optical system. Although an effect of satisfactorily correcting chromatic aberration is expected by using the diffractive optical element, flare caused by unnecessary diffraction light other than first-order diffraction light occurs. By not including the diffractive optical element, it is possible to prevent the occurrence of specific flare due to the surface having the diffraction grating.

In the imaging optical system according to the present invention, it is more effective to have the following configuration.

It is preferable that the aperture diaphragm S is disposed closer to the image side than the second lens group G2. Accordingly, the aperture diaphragm diameter can be reduced, and thus the entire product can be reduced.

Next, lens configurations of examples according to the imaging optical system of the present invention will be described. In the following description, the lens configuration will be described in order from the object side to the image side.

### Example 1

FIG. 1 is a lens configuration diagram of an imaging optical system of Example 1 of the present invention.

The first lens group G1 includes a group 1a and a group 1b, and has a positive refractive power as a whole. The group 1a is composed of a biconvex positive lens and a meniscus-shaped positive lens having a convex surface toward the object side. The group 1b includes: a cemented lens including a negative lens L1na having a meniscus shape that is convex toward the object side, and a positive lens having a meniscus shape that is convex toward the object side; a negative lens L1nb having a biconcave shape; and a cemented lens including a negative lens having a meniscus shape that is convex toward the object side and a positive lens having a biconvex shape.

The second lens group G2 is composed of a negative lens having a meniscus shape that is convex toward the object side, and has a negative refractive power as a whole. Further, the second lens group G2 moves on the optical axis from the object side to the image side while focusing from the infinite distance object to the close distance object.

The third lens group G3 includes a cemented lens including a biconvex positive lens and a biconcave negative lens, an aperture diaphragm S, a vibration reduction group Gos, and a rear group Gr, and has a positive refractive power as a whole. The vibration reduction group Gos includes a cemented lens including a positive lens having a biconvex shape and a negative lens having a biconcave shape, and a negative lens having a biconcave shape. The rear group Gr includes a cemented lens including a biconvex positive lens and a meniscus negative lens concave toward the object side, a biconvex positive lens, a meniscus positive lens concave toward the object side, a biconcave negative lens, and a meniscus negative lens concave toward the object side. In addition, the vibration reduction group Gos is moved in a direction including a component perpendicular to the optical axis so as to reduce the image blur caused by the shake of the imaging optical system.

### Example 21

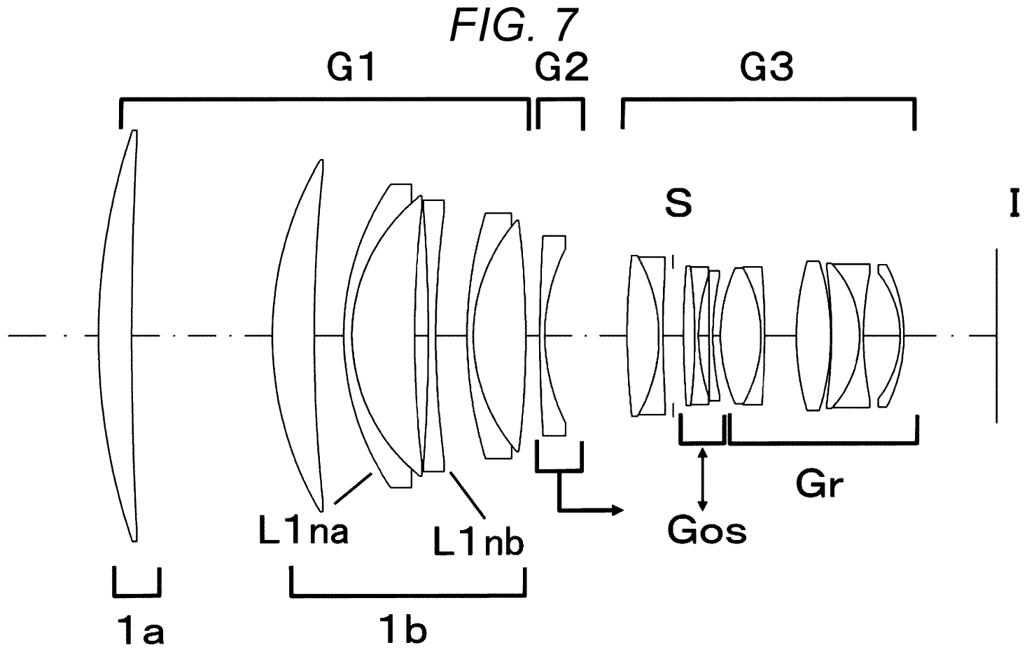

FIG. 7 is a lens configuration diagram of an imaging optical system of Example 2 of the present invention.

The first lens group G1 includes a group 1a and a group 1b, and has a positive refractive power as a whole. The group 1a is composed of a positive lens having a meniscus shape with a convex surface facing the object side. The group 1b includes: a positive lens having a meniscus shape with a surface convex toward the object side; a cemented lens including a negative lens L1na having a meniscus shape with a surface convex toward the object side, and a positive lens having a meniscus shape with a surface convex toward the object side; a negative lens L1nb having a biconcave shape; and a cemented lens including a negative lens having a meniscus shape with a surface convex toward the object side, and a positive lens having a biconcave shape.

The second lens group G2 is composed of a negative lens having a meniscus shape that is convex toward the object side, and has a negative refractive power as a whole. Further, the second lens group G2 moves on the optical axis from the object side to the image side while focusing from the infinite distance object to the close distance object.

The third lens group G3 includes a cemented lens including a biconvex positive lens and a biconcave negative lens, an aperture diaphragm S, a vibration reduction group Gos, and a rear group Gr, and has a negative refractive power as a whole. The vibration reduction group Gos includes a cemented lens including a positive lens having a biconvex shape and a negative lens having a biconcave shape, and a negative lens having a biconcave shape. The rear group Gr includes: a cemented lens including a biconvex positive lens and a meniscus negative lens concave toward the object side; a biconvex positive lens; a cemented lens including a meniscus positive lens concave toward the object side, and a biconcave negative lens; and a meniscus negative lens concave toward the object side. In addition, the vibration reduction group Gos is moved in a direction including a component perpendicular to the optical axis so as to reduce the image blur caused by the shake of the imaging optical system.

### Example 31

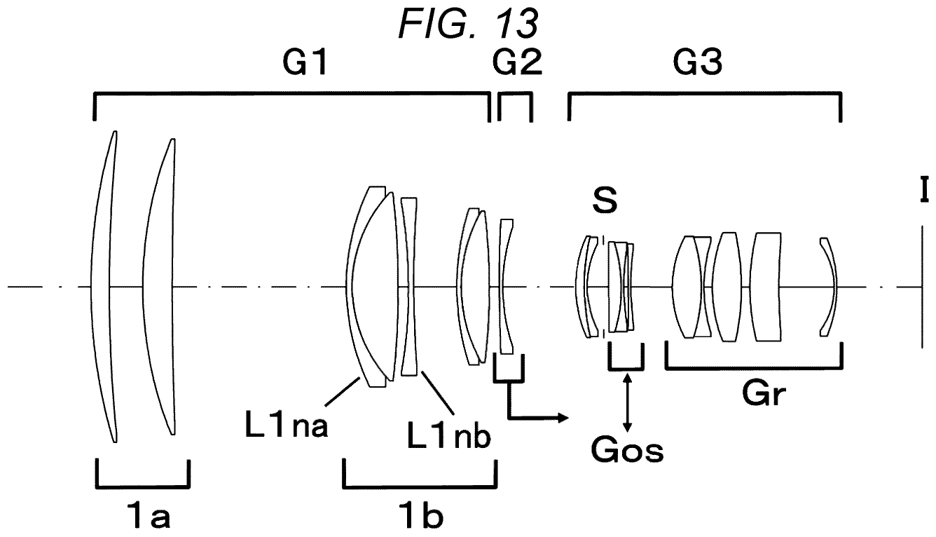

FIG. 13 is a lens configuration diagram of the imaging optical system of Example 3 of the present invention.

The first lens group G1 includes a group 1a and a group 1b, and has a positive refractive power as a whole. The group 1a is composed of a positive lens having a meniscus shape that is convex toward the object side and a positive lens having a meniscus shape that is convex toward the object side. The group 1b includes: a cemented lens including a negative lens L1na having a meniscus shape that is convex toward the object side, and a positive lens having a biconvex shape; a negative lens L1nb having a biconcave shape; and a cemented lens including a negative lens having a meniscus shape that is convex toward the object side, and a positive lens having a biconvex shape.

The second lens group G2 is composed of a negative lens having a meniscus shape that is convex toward the object side, and has a negative refractive power as a whole. Further, the second lens group G2 moves on the optical axis from the object side to the image side while focusing from the infinite distance object to the close distance object.

The third lens group G3 includes a cemented lens including a positive lens having a meniscus shape that is convex toward the object side and a negative lens having a meniscus shape that is convex toward the object side, an aperture diaphragm S, a vibration reduction group Gos, and a rear group Gr, and has a negative refractive power as a whole. The vibration reduction group Gos includes a cemented lens including a positive lens having a biconvex shape and a negative lens having a biconcave shape, and a negative lens having a biconcave shape. The rear group Gr includes a cemented lens including a positive lens having a biconvex shape and a negative lens having a biconcave shape, a positive lens having a biconvex shape, a positive lens having a meniscus shape that is convex toward the object side, and a negative lens having a meniscus shape that is concave toward the object side. In addition, the vibration reduction group Gos is moved in a direction including a component perpendicular to the optical axis so as to reduce the image blur caused by the shake of the imaging optical system.

### Example 4

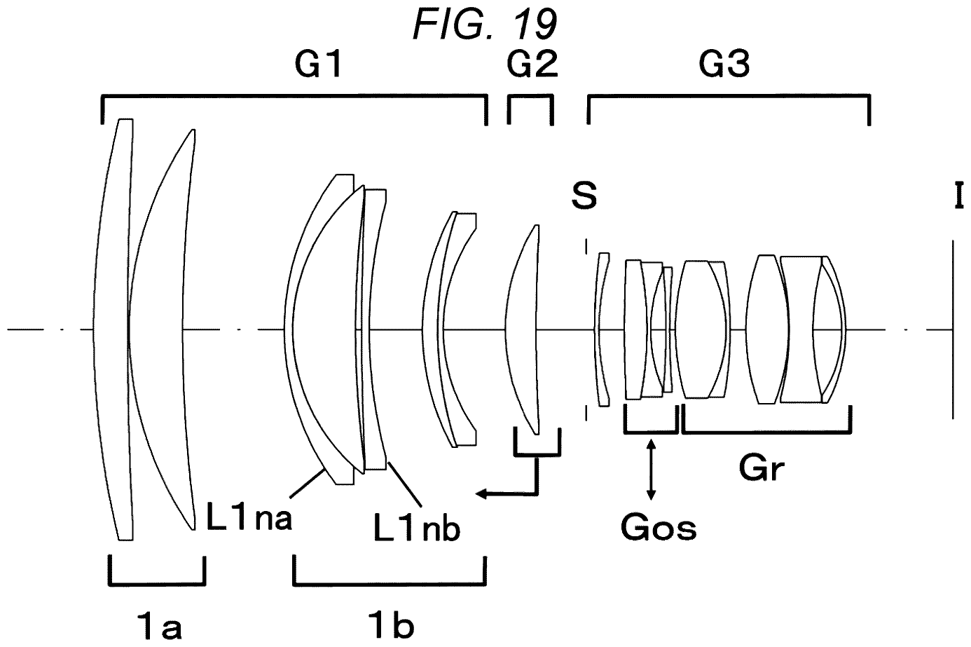

FIG. 19 is a lens configuration diagram of the imaging optical system of Example 4 of the present invention.

The first lens group G1 includes a group 1a and a group 1b, and has a positive refractive power as a whole. The group 1a is composed of a positive lens having a meniscus shape that is convex toward the object side and a positive lens having a meniscus shape that is convex toward the object side. The group 1b includes a cemented lens including a negative lens L1na of a meniscus shape that is convex toward the object side and a positive lens of a biconvex shape, a negative lens L1nb of a meniscus shape that is convex toward the object side, and a cemented lens including a positive lens of a meniscus shape that is convex toward the object side and a negative lens of a meniscus shape that is convex toward the object side.

The second lens group G2 is composed of a positive lens having a meniscus shape that is convex toward the object side, and has a positive refractive power as a whole. Further, the second lens group G2 moves on the optical axis from the image side to the object side while focusing from the infinite distance object to the close distance object.

The third lens group G3 includes a negative lens having a meniscus shape that is convex toward the object side, a vibration reduction group Gos, and a rear group Gr, and has a negative refractive power as a whole. The vibration reduction group Gos includes a cemented lens including a positive lens having a biconvex shape and a negative lens having a biconcave shape, and a negative lens having a biconcave shape. The rear group Gr includes a cemented lens including a biconvex positive lens and a meniscus negative lens concave toward the object side, a biconvex positive lens, a biconcave negative lens, and a meniscus negative lens concave toward the object side. In addition, the vibration reduction group Gos is moved in a direction including a component perpendicular to the optical axis so as to reduce the image blur caused by the shake of the imaging optical system.

The aperture diaphragm S is disposed between the second lens group G2 and the third lens group G3.

### Example 51

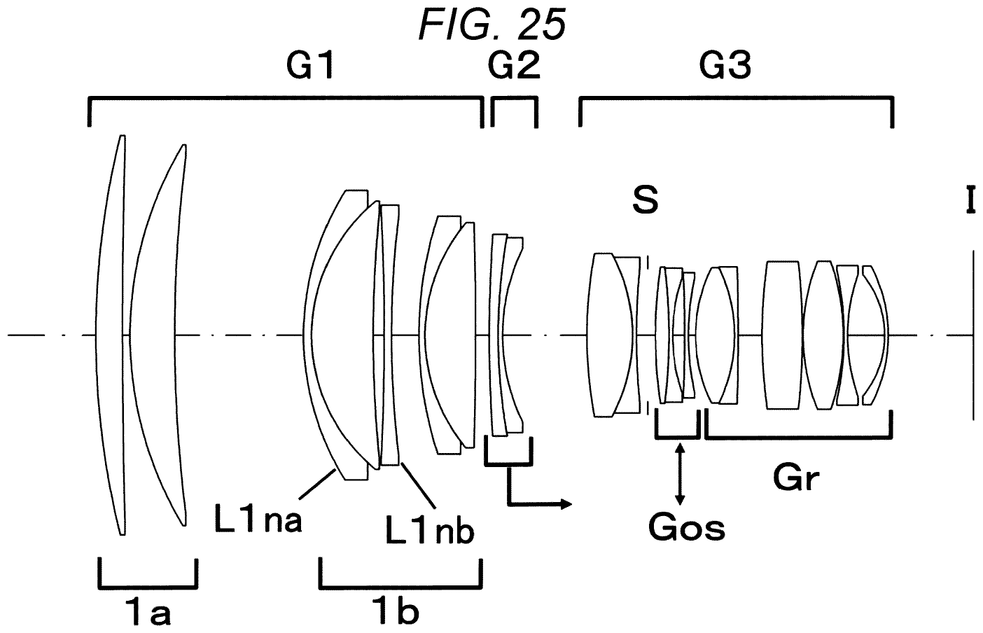

FIG. 25 is a lens configuration diagram of an imaging optical system of Example 5 of the present invention.

The first lens group G1 includes a group 1a and a group 1b, and has a positive refractive power as a whole. The group 1a is composed of a positive lens having a meniscus shape that is convex toward the object side and a positive lens having a meniscus shape that is convex toward the object side. The group 1b includes a cemented lens including a negative lens L1na having a meniscus shape that is convex toward the object side and a positive lens having a meniscus shape that is convex toward the object side, a negative lens L1nb having a biconcave shape, and a cemented lens including a negative lens having a meniscus shape that is convex toward the object side and a positive lens having a biconcave shape.

The second lens group G2 is composed of a cemented lens including a positive lens having a meniscus shape that is convex toward the object side and a negative lens having a meniscus shape that is convex toward the object side, and has a negative refractive power as a whole. Further, the second lens group G2 moves on the optical axis from the object side to the image side while focusing from the infinite distance object to the close distance object.

The third lens group G3 includes a cemented lens including a biconvex positive lens and a biconcave negative lens, an aperture diaphragm S, a vibration reduction group Gos, and a rear group Gr, and has a positive refractive power as a whole. The vibration reduction group Gos includes a cemented lens including a positive lens having a biconvex shape and a negative lens having a biconcave shape, and a negative lens having a biconcave shape. The rear group Gr includes a cemented lens including a biconvex positive lens and a negative lens of a meniscus shape concave toward the object side, a biconvex positive lens, a biconvex positive lens, and a negative lens of a meniscus shape concave toward the object side. In addition, the vibration reduction group Gos is moved in a direction including a component perpendicular to the optical axis so as to reduce the image blur caused by the shake of the imaging optical system.

### Example 61

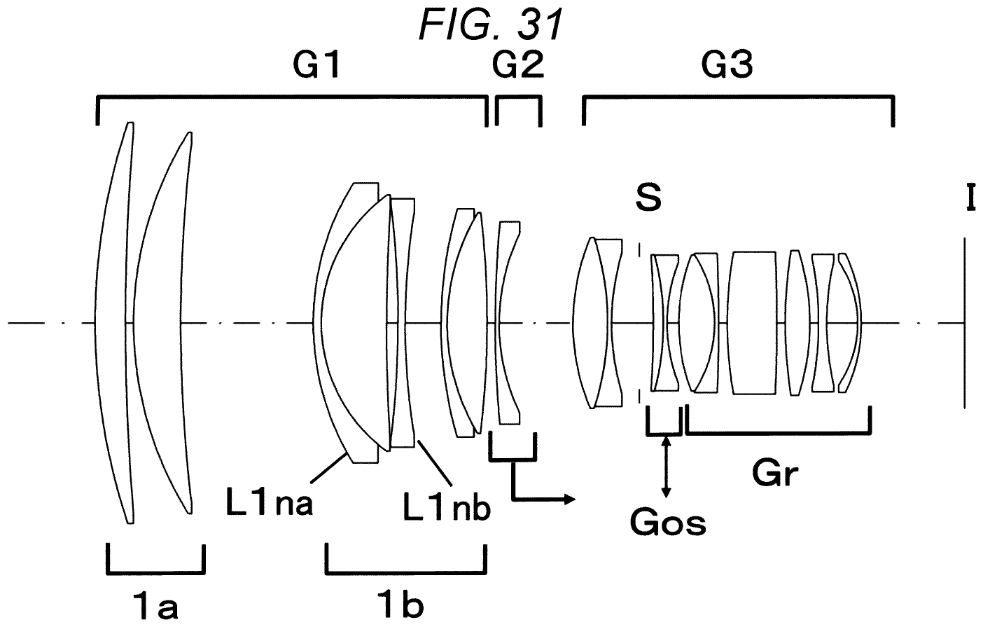

FIG. 31 is a lens configuration diagram of an imaging optical system of Example 6 of the present invention.

The first lens group G1 includes a group 1a and a group 1b, and has a positive refractive power as a whole. The group 1a is composed of a positive lens having a meniscus shape that is convex toward the object side and a positive lens having a meniscus shape that is convex toward the object side. The group 1b includes a cemented lens including a negative lens L1na having a meniscus shape that is convex toward the object side and a positive lens having a meniscus shape that is convex toward the object side, a negative lens L1nb having a biconcave shape, and a cemented lens including a negative lens having a meniscus shape that is convex toward the object side and a positive lens having a biconcave shape.

The second lens group G2 is composed of a negative lens having a meniscus shape that is convex toward the object side, and has a negative refractive power as a whole. Further, the second lens group G2 moves on the optical axis from the object side to the image side while focusing from the infinite distance object to the close distance object.

The third lens group G3 includes a cemented lens including a biconvex positive lens and a biconcave negative lens, an aperture diaphragm S, a vibration reduction group Gos, and a rear group Gr, and has a positive refractive power as a whole. The vibration reduction group Gos includes a cemented lens including a positive lens having a biconvex shape and a negative lens having a biconcave shape and an aspherical surface on the image surface side. The rear group Gr includes a cemented lens including a biconvex positive lens and a negative lens of a meniscus shape concave toward the object side, a biconvex positive lens, a biconvex positive lens, a biconcave negative lens, and a negative lens of a meniscus shape concave toward the object side. In addition, the vibration reduction group Gos is moved in a direction including a component perpendicular to the optical axis so as to reduce the image blur caused by the shake of the imaging optical system.

Specific numerical data of each example according to the imaging optical system of the present invention will be shown below.

In [Surface data], the surface number is a number of a lens surface or an aperture diaphragm counted from the object side, r is a curvature radius of each surface, d is a distance between surfaces, nd is a refractive index with respect to a d line (wavelength of 587.56 nm), vd is an Abbe number with respect to the d line, and PgF is a partial dispersion ratio with respect to the g line and the F line.

An asterisk (*) attached to a surface number indicates that the lens surface shape is an aspherical surface. In addition, BF represents a back focus.

The (diaphragm) attached to the surface number indicates that the aperture diaphragm is located at that position. Infinite (∞) is written for the curvature radius with respect to the plane or the aperture diaphragm.

[Aspherical surface data] shows values of each coefficient for giving the aspherical shape of the lens surface denoted by * in [Surface data]. In a case where a displacement from the optical axis in a direction perpendicular to the optical axis is y, a displacement (sag) from an intersection of the optical axis and the aspherical surface in an optical axis direction is z, a curvature radius of a reference spherical surface is r, a conic coefficient is K, and fourth-order, sixth-order, and eighth-order aspherical coefficients are A4, A6, and A8, respectively, it is assumed that coordinates of the aspherical surface are represented by the following expression.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8}$$

[Various data] indicates values such as a focal length in each focal length state.

The [Variable Distance Data] shows the variable interval and the BF value in each focal length state.

The lens group data shows the surface number of the lens group closest to the object side and the total focal length of the entire group.

In all the values of the specifications described below, the unit of the focal length f, the curvature radius r, the lens surface distance d, and other lengths is millimeter (mm) unless otherwise noted. However, the present invention is not limited thereto because the same optical performance can be obtained in both the proportional magnification and the proportional reduction in the optical system.

In addition, in the aberration diagrams corresponding to the respective examples, d, g, and C represent a d line, a g line, and a C line, respectively, and ΔS and ΔM represent a sagittal image surface and a meridional image plane, respectively.

### Numerical Example 1

Unit: mm
[Surface data]

| Surface number: | r | d | nd | vd | PgF |
|---|---|---|---|---|---|
| Object surface | ∞ | (d0) | | | |
| 1 | 212.8145 | 7.4926 | 1.48749 | 70.44 | 0.5306 |
| 2 | −3741.0747 | 1.9000 | | | |
| 3 | 88.7689 | 11.1469 | 1.43700 | 95.10 | 0.5336 |
| 4 | 311.8544 | 32.0000 | | | |
| 5 | 62.7550 | 2.0000 | 1.72916 | 54.67 | 0.5453 |
| 6 | 41.2488 | 15.2817 | 1.43700 | 95.10 | 0.5336 |
| 7 | 326.4366 | 3.0213 | | | |
| 8 | −352.0999 | 1.8000 | 1.85451 | 25.15 | 0.6103 |
| 9 | 192.6785 | 6.5400 | | | |
| 10 | 100.1622 | 1.5000 | 1.75500 | 52.32 | 0.5473 |
| 11 | 47.0478 | 11.2712 | 1.59410 | 60.47 | 0.5552 |
| 12 | −256.8810 | (d12) | | | |
| 13 | 424.4891 | 1.2000 | 1.51823 | 58.96 | 0.5442 |
| 14 | 49.7913 | (d14) | | | |
| 15 | 119.8435 | 8.0834 | 1.85883 | 30.00 | 0.5979 |
| 16 | −42.6903 | 1.0000 | 1.80440 | 39.58 | 0.5762 |
| 17 | 155.7968 | 2.9331 | | | |
| 18 (diaphragm) | ∞ | 1.9984 | | | |
| 19 | 126.1592 | 3.1081 | 1.98612 | 16.48 | 0.6656 |
| 20 | −164.7066 | 0.9000 | 1.71300 | 53.94 | 0.5442 |
| 21 | 48.6121 | 2.8437 | | | |
| 22 | −750.1799 | 0.9000 | 1.85451 | 25.15 | 0.6103 |
| 23 | 66.7431 | 1.8897 | | | |
| 24 | 45.2550 | 9.5268 | 1.77250 | 49.63 | 0.5504 |
| 25 | −32.6534 | 0.9000 | 2.00069 | 25.46 | 0.6136 |
| 26 | −360.8672 | 6.8814 | | | |
| 27 | 80.6631 | 10.0000 | 1.77047 | 29.74 | 0.5951 |
| 28 | −71.9091 | 0.1500 | | | |
| 29 | −192.5873 | 9.7103 | 1.56732 | 42.84 | 0.5744 |
| 30 | −48.2101 | 0.1500 | | | |
| 31 | −60.9006 | 0.9000 | 1.57144 | 71.61 | 0.5419 |
| 32 | 78.9803 | 7.3037 | | | |
| 33 | −26.3842 | 0.9000 | 1.98612 | 16.48 | 0.6656 |
| 34 | −42.1224 | (BF) | | | |
| Image surface | ∞ | | | | |

[Various types of data]

| | INF | 1700 mm |
|---|---|---|
| Focal length: | 194.30 | 153.36 |
| F number: | 2.07 | 2.25 |
| Full angle of view 2ω | 12.45 | 9.64 |
| Image height Y: | 21.63 | 21.63 |
| Total length of lens: | 212.00 | 212.00 |

[Variable Distance Data]

| | INF | 1700 mm |
|---|---|---|
| d0 | ∞ | 1488.0000 |
| d12 | 3.4000 | 17.9678 |
| d14 | 20.9224 | 6.3545 |
| BF | 22.4456 | 22.4457 |

[Lens group data]

| Group | Starting surface | Focal length |
|---|---|---|
| G1 | 1 | 124.55 |
| G2 | 13 | −108.97 |
| G3 | 15 | 1807.38 |
| 1a | 1 | 167.70 |
| 1b | 5 | 323.74 |
| Gos | 19 | −52.92 |
| Gr | 24 | 51.80 |

### Numerical Example 2

Unit: mm
[Surface data]

| Surface number: | r | d | nd | vd | PgF |
|---|---|---|---|---|---|
| Object surface | ∞ | (d0) | | | |
| 1 | 157.5957 | 8.0000 | 1.59349 | 67.00 | 0.5366 |
| 2 | 921.0193 | 34.0000 | | | |
| 3 | 85.7774 | 10.0683 | 1.43700 | 95.10 | 0.5336 |
| 4 | 388.5532 | 7.1670 | | | |
| 5 | 66.0429 | 2.0000 | 1.69680 | 55.46 | 0.5426 |
| 6 | 43.7541 | 15.1337 | 1.43700 | 95.10 | 0.5336 |
| 7 | 266.2950 | 3.3888 | | | |
| 8 | −415.1074 | 1.8000 | 1.90110 | 27.06 | 0.6072 |
| 9 | 226.1287 | 7.5465 | | | |
| 10 | 102.8754 | 1.5000 | 1.71300 | 53.94 | 0.5442 |
| 11 | 43.2319 | 12.6650 | 1.55032 | 75.50 | 0.5401 |
| 12 | −230.5175 | (d12) | | | |
| 13 | 393.4221 | 1.2000 | 1.51823 | 58.96 | 0.5442 |
| 14 | 47.9295 | (d14) | | | |
| 15 | 178.5940 | 7.7339 | 1.85883 | 30.00 | 0.5979 |
| 16 | −39.3760 | 1.0000 | 1.80440 | 39.58 | 0.5762 |
| 17 | 306.2211 | 2.4681 | | | |
| 18 (diaphragm) | ∞ | 2.4757 | | | |
| 19 | 232.1757 | 2.7082 | 1.98612 | 16.48 | 0.6656 |
| 20 | −136.1022 | 0.9000 | 1.69680 | 55.46 | 0.5426 |
| 21 | 46.6978 | 2.5660 | | | |
| 22 | −6382.2488 | 0.9000 | 1.80610 | 33.27 | 0.5884 |
| 23 | 68.4057 | 1.8152 | | | |
| 24 | 40.5851 | 9.7684 | 1.71300 | 53.94 | 0.5442 |
| 25 | −33.8193 | 0.9000 | 2.00069 | 25.46 | 0.6136 |
| 26 | −199.3648 | 7.6595 | | | |
| 27 | 66.2565 | 8.2767 | 1.73037 | 32.23 | 0.5899 |
| 28 | −60.2793 | 0.1500 | | | |
| 29 | −116.6478 | 6.9058 | 1.62280 | 57.05 | 0.5464 |
| 30 | −26.0788 | 0.9000 | 1.59282 | 68.62 | 0.5440 |
| 31 | 77.3746 | 8.8529 | | | |
| 32 | −24.9346 | 0.9000 | 1.98612 | 16.48 | 0.6656 |
| 33 | −38.0814 | (BF) | | | |
| Image surface | ∞ | | | | |

[Various types of data]

| | INF | 1700 mm |
|---|---|---|
| Focal length: | 194.30 | 152.59 |
| F number: | 2.06 | 2.16 |
| Total angle of view 2ω: | 12.45 | 9.77 |
| Image height Y: | 21.63 | 21.63 |
| Total length of lens: | 217.00 | 217.00 |

[Variable Distance Data]

| | INF | 1700 mm |
|---|---|---|
| d0 | ∞ | 1483.0000 |
| d12 | 3.4000 | 16.5023 |
| d14 | 19.8883 | 6.7859 |
| BF | 22.3621 | 22.3622 |

[Lens group data]

| Group | Starting surface | Focal length |
|---|---|---|
| G1 | 1 | 117.22 |
| G2 | 13 | −105.44 |
| G3 | 15 | −1742.11 |
| 1a | 1 | 319.11 |
| 1b | 3 | 156.30 |
| Gos | 19 | −48.70 |
| Gr | 24 | 50.89 |

### Numerical Example 3

Unit: mm
[Surface data]

| Surface number: | r | d | nd | vd | PgF |
|---|---|---|---|---|---|
| Object surface | ∞ | (d0) | | | |
| 1 | 190.4521 | 6.3143 | 1.48749 | 70.44 | 0.5306 |
| 2 | 537.0147 | 11.5030 | | | |
| 3 | 139.2066 | 10.1815 | 1.43700 | 95.10 | 0.5336 |
| 4 | 1392.0544 | 60.2047 | | | |
| 5 | 80.3098 | 2.0000 | 1.69680 | 55.46 | 0.5426 |
| 6 | 48.0217 | 15.8120 | 1.43700 | 95.10 | 0.5336 |
| 7 | −292.7233 | 3.5870 | | | |
| 8 | −178.3030 | 1.8000 | 1.90110 | 27.06 | 0.6072 |
| 9 | 433.9555 | 14.8253 | | | |
| 10 | 90.1247 | 1.5000 | 1.69680 | 55.46 | 0.5426 |
| 11 | 53.5632 | 9.7241 | 1.55397 | 71.76 | 0.5392 |
| 12 | −212.7083 | (d12) | | | |
| 13 | 521.3103 | 1.2000 | 1.65844 | 50.86 | 0.5576 |
| 14 | 65.4784 | (d14) | | | |
| 15 | 42.7563 | 3.0534 | 1.94594 | 17.98 | 0.6546 |
| 16 | 78.4619 | 1.0000 | 1.69895 | 30.05 | 0.6028 |
| 17 | 34.0994 | 5.5828 | | | |
| 18 (diaphragm) | ∞ | 1.8102 | | | |
| 19 | −10393.9834 | 4.3000 | 1.84666 | 23.78 | 0.6192 |
| 20 | −53.4040 | 0.9000 | 1.77250 | 49.63 | 0.5504 |
| 21 | 89.8258 | 1.5000 | | | |
| 22 | −560.1647 | 0.9000 | 1.71300 | 53.94 | 0.5442 |
| 23 | 109.3462 | 14.4675 | | | |
| 24 | 38.7656 | 10.0000 | 1.73037 | 32.23 | 0.5899 |
| 25 | −57.1805 | 0.9000 | 2.00069 | 25.46 | 0.6136 |
| 26 | 54.8428 | 2.8345 | | | |
| 27 | 50.7506 | 10.0000 | 1.60342 | 38.01 | 0.5828 |
| 28 | −89.2755 | 2.9530 | | | |
| 29 | 78.9065 | 10.0000 | 1.71736 | 29.50 | 0.6040 |
| 30 | 202.5054 | 19.0022 | | | |
| 31 | −26.3135 | 0.9000 | 1.98612 | 16.48 | 0.6656 |
| 32 | −44.4795 | (BF) | | | |
| Image surface | ∞ | | | | |

[Various types of data]

| | INF | 2000 mm |
|---|---|---|
| Focal length: | 290.30 | 204.27 |
| F number: | 2.90 | 3.12 |
| Total angle of view 2ω | 8.35 | 6.26 |
| Image height Y: | 21.63 | 21.63 |
| Total length of lens: | 286.83 | 286.83 |

[Variable Distance Data]

| | INF | 2000 mm |
|---|---|---|
| d0 | ∞ | 1713.1749 |
| d12 | 3.4000 | 18.5066 |
| d14 | 25.1140 | 10.0074 |
| BF | 29.5555 | 29.5557 |

[Lens group data]

| Group | Starting surface | Focal length |
|---|---|---|
| G1 | 1 | 136.72 |
| G2 | 13 | −113.85 |
| G3 | 15 | −303.93 |
| 1a | 1 | 226.61 |
| 1b | 5 | 184.48 |
| Gos | 19 | −65.82 |
| Gr | 24 | 66.80 |

### Numerical Example 4

Unit: mm
[Surface data]

| Surface number: | r | d | nd | vd | PgF |
|---|---|---|---|---|---|
| Object surface | ∞ | (d0) | | | |
| 1 | 212.5532 | 8.0000 | 1.59349 | 67.00 | 0.5366 |
| 2 | 904.8287 | 0.3836 | | | |
| 3 | 83.8527 | 12.6164 | 1.43700 | 95.10 | 0.5336 |
| 4 | 347.1350 | 24.0000 | | | |
| 5 | 61.7203 | 2.0000 | 1.69680 | 55.46 | 0.5426 |
| 6 | 44.0332 | 14.8240 | 1.43700 | 95.10 | 0.5336 |
| 7 | 252.5695 | 1.4113 | | | |
| 8 | 682.0781 | 1.8000 | 1.90110 | 27.06 | 0.6072 |
| 9 | 119.8764 | 12.5270 | | | |
| 10 | 58.9734 | 3.5827 | 1.94594 | 17.98 | 0.6546 |
| 11 | 88.7654 | 1.3000 | 2.00100 | 29.13 | 0.5995 |
| 12 | 41.4854 | (d12) | | | |
| 13 | 47.2689 | 7.2980 | 1.59282 | 68.62 | 0.5440 |
| 14 | 418.7619 | (d14) | | | |
| 15 (diaphragm) | ∞ | 2.0000 | | | |
| 16 | 149.2274 | 1.0000 | 1.68430 | 26.81 | 0.6232 |
| 17 | 57.9269 | 6.0051 | | | |
| 18 | 337.6848 | 5.2879 | 1.98612 | 16.48 | 0.6656 |
| 19 | −90.0821 | 0.9000 | 1.61340 | 44.27 | 0.5633 |
| 20 | 36.3468 | 3.5896 | | | |
| 21 | −165.9201 | 0.9000 | 1.85883 | 30.00 | 0.5979 |
| 22 | 172.3448 | 1.3225 | | | |
| 23 | 56.8223 | 11.9177 | 1.72825 | 28.32 | 0.6075 |
| 24 | −32.6031 | 1.0000 | 1.94594 | 17.98 | 0.6546 |
| 25 | −88.2138 | 3.7000 | | | |
| 26 | 53.2003 | 10.0000 | 1.56732 | 42.84 | 0.5744 |
| 27 | −48.2475 | 0.1500 | | | |
| 28 | −66.3037 | 5.6446 | 1.49700 | 81.61 | 0.5389 |
| 29 | 62.3923 | 6.7818 | | | |
| 30 | −28.4746 | 0.9000 | 1.98612 | 16.48 | 0.6656 |
| 31 | −37.5769 | (BF) | | | |
| Image surface | ∞ | | | | |

[Various types of data]

| | INF | 1900 mm |
|---|---|---|
| Focal length: | 193.00 | 164.58 |
| F number: | 2.06 | 2.33 |
| Total angle of view 2ω: | 12.57 | 10.17 |
| Image height Y: | 21.63 | 21.63 |
| Total length of lens: | 202.47 | 202.47 |

[Variable Distance Data]

| | INF | 1900 mm |
|---|---|---|
| d0 | ∞ | 1697.5314 |
| d12 | 14.6449 | 3.6654 |
| d14 | 11.7595 | 22.7392 |
| BF | 25.2219 | 25.2219 |

[Lens group data]

| Group | Starting surface | Focal length |
|---|---|---|
| G1 | 1 | 481.54 |
| G2 | 13 | 89.23 |
| G3 | 15 | −111.22 |
| 1a | 1 | 163.40 |
| 1b | 5 | −123.67 |
| Gos | 18 | −49.80 |
| Gr | 23 | 49.15 |

### Numerical Example 5

Unit: mm
[Surface data]

| Surface number: | r | d | nd | vd | PgF |
|---|---|---|---|---|---|
| Object surface | ∞ | (d0) | | | |
| 1 | 209.1635 | 6.5775 | 1.48749 | 70.44 | 0.5306 |
| 2 | 1797.8328 | 1.9000 | | | |
| 3 | 93.3731 | 11.0915 | 1.43700 | 95.10 | 0.5336 |
| 4 | 365.5515 | 32.0000 | | | |
| 5 | 69.0349 | 2.0000 | 1.69680 | 55.46 | 0.5426 |
| 6 | 43.7016 | 15.2020 | 1.43700 | 95.10 | 0.5336 |
| 7 | 319.9534 | 2.7434 | | | |
| 8 | −626.0523 | 1.8000 | 1.90110 | 27.06 | 0.6072 |
| 9 | 257.8342 | 6.8065 | | | |
| 10 | 97.4850 | 1.5000 | 1.71300 | 53.94 | 0.5442 |
| 11 | 44.4323 | 12.5390 | 1.59282 | 68.62 | 0.5440 |
| 12 | −886.8146 | (d12) | | | |
| 13 | 383.4827 | 2.2198 | 1.69680 | 55.46 | 0.5426 |
| 14 | 142.9200 | 1.1000 | 1.48749 | 70.44 | 0.5306 |
| 15 | 50.2867 | (d15) | | | |
| 16 | 110.4575 | 11.3200 | 1.85883 | 30.00 | 0.5979 |
| 17 | −43.2879 | 1.0000 | 1.80000 | 29.84 | 0.6017 |
| 18 | 181.9370 | 2.8078 | | | |
| 19 (diaphragm) | ∞ | 1.9464 | | | |
| 20 | 118.9931 | 3.3417 | 1.98612 | 16.48 | 0.6656 |
| 21 | −137.1580 | 0.9000 | 1.77250 | 49.63 | 0.5504 |
| 22 | 44.8454 | 3.0414 | | | |
| 23 | −288.8846 | 0.9000 | 1.80518 | 25.46 | 0.6157 |
| 24 | 70.3717 | 1.8000 | | | |
| 25 | 38.2028 | 9.6908 | 1.69680 | 55.46 | 0.5426 |
| 26 | −38.7924 | 0.9000 | 2.00100 | 29.13 | 0.5995 |
| 27 | −572.5354 | 5.9477 | | | |
| 28 | 133.8498 | 10.0000 | 1.80610 | 33.27 | 0.5884 |
| 29 | −166.6990 | 0.1500 | | | |
| 30 | 49.7691 | 10.0000 | 1.60342 | 38.01 | 0.5828 |
| 31 | −56.2892 | 0.1500 | | | |
| 32 | −76.9729 | 0.9223 | 1.59282 | 68.62 | 0.5440 |
| 33 | 46.6786 | 9.1784 | | | |
| 34 | −24.0246 | 0.9000 | 1.98612 | 16.48 | 0.6656 |
| 35 | −37.4041 | (BF) | | | |
| Image surface | ∞ | | | | |

[Various types of data]

| | INF | 1700 mm |
|---|---|---|
| Focal length: | 194.30 | 152.04 |
| F number: | 2.07 | 2.24 |
| Full angle of view 2ω | 12.45 | 9.57 |
| Image height Y: | 21.63 | 21.63 |
| Total length of lens | 217.87 | 217.87 |

[Variable Distance Data]

| | INF | 1700 mm |
|---|---|---|
| d0 | ∞ | 1482.1330 |
| d12 | 3.4000 | 18.0315 |
| d15 | 20.8947 | 6.2632 |
| BF | 21.1963 | 21.1962 |

[Lens group data]

| Group | Starting surface | Focal length |
|---|---|---|
| G1 | 1 | 126.42 |
| G2 | 13 | −107.38 |
| G3 | 16 | 1258.39 |
| 1a | 1 | 179.89 |
| 1b | 5 | 302.58 |
| Gos | 20 | −46.73 |
| Gr | 25 | 48.00 |

### Numerical Example 6

Unit: mm
[Surface data]

| Surface number: | r | d | nd | vd | PgF |
|---|---|---|---|---|---|
| Object surface | ∞ | (d0) | | | |
| 1 | 159.1112 | 7.5000 | 1.48749 | 70.44 | 0.5306 |
| 2 | 583.1761 | 2.0000 | | | |
| 3 | 90.4243 | 11.6561 | 1.43700 | 95.10 | 0.5336 |
| 4 | 378.2022 | 32.7767 | | | |
| 5 | 66.8508 | 2.0000 | 1.71300 | 53.94 | 0.5442 |
| 6 | 39.7714 | 16.0715 | 1.43700 | 95.10 | 0.5336 |
| 7 | 464.4841 | 2.8100 | | | |
| 8 | −251.3297 | 1.8000 | 1.77047 | 29.74 | 0.5951 |
| 9 | 175.5525 | 8.8857 | | | |
| 10 | 103.7283 | 1.5000 | 1.71300 | 53.94 | 0.5442 |
| 11 | 54.2772 | 9.8652 | 1.59282 | 68.62 | 0.5440 |
| 12 | −234.1227 | (d12) | | | |
| 13 | 268.6773 | 1.0000 | 1.59349 | 67.00 | 0.5366 |
| 14 | 52.1505 | (d14) | | | |
| 15 | 55.4558 | 8.5417 | 1.92119 | 23.96 | 0.6202 |
| 16 | −70.0040 | 1.0000 | 1.85451 | 25.15 | 0.6103 |
| 17 | 61.7226 | 6.8202 | | | |
| 18 (diaphragm) | ∞ | 3.5116 | | | |
| 19 | −244.0228 | 2.4718 | 1.94594 | 17.98 | 0.6546 |
| 20 | −65.8073 | 0.9000 | 1.76450 | 9.09 | 0.5528 |
| 21* | 41.0665 | 2.9308 | | | |
| 22 | 47.4921 | 8.8793 | 1.77250 | 49.63 | 0.5504 |
| 23 | −31.7013 | 1.0000 | 2.00069 | 25.46 | 0.6136 |
| 24 | −402.5213 | 2.1321 | | | |
| 25 | 100.8842 | 12.2400 | 1.65412 | 39.68 | 0.5737 |
| 26 | −422.8292 | 2.0866 | | | |
| 27 | 115.1365 | 6.0864 | 1.77047 | 29.74 | 0.5951 |
| 28 | −59.1836 | 2.1581 | | | |
| 29 | −82.3617 | 2.0000 | 1.59282 | 68.62 | 0.5440 |
| 30 | 67.6562 | 7.6515 | | | |
| 31 | −27.7967 | 0.9000 | 1.98612 | 16.48 | 0.6656 |
| 32 | −40.0978 | (BF) | | | |
| Image surface | ∞ | | | | |

[Aspherical surface data]

| | Surface 21 |
|---|---|
| K | 0.00000 |
| A4 | −1.48938E−06 |
| A6 | −1.16771E−09 |
| A8 | 8.46462E−13 |

[Various types of data]

| | INF | 1800 mm |
|---|---|---|
| Focal length: | 194.00 | 159.31 |
| F number: | 2.06 | 2.24 |
| Total angle of view 2ω | 12.54 | 9.83 |
| Image height Y: | 21.63 | 21.63 |
| Total length of lens: | 215.00 | 215.00 |

[Variable Distance Data]

| | INF | 1800 mm |
|---|---|---|
| d0 | ∞ | 1585.0000 |
| d12 | 2.0000 | 16.1577 |
| d14 | 18.2512 | 4.0935 |
| BF | 25.5735 | 25.5735 |

[Lens group data]
Group Starting surface Focal length

| | | |
|---|---|---|
| G1 | 1 | 130.82 |
| G2 | 13 | −109.22 |
| G3 | 15 | 419.58 |
| 1a | 1 | 169.20 |
| 1b | 5 | 341.50 |
| Gos | 19 | −50.44 |
| Gr | 22 | 52.05 |

In addition, a list of corresponding values of the conditional expressions in each of these examples is shown.

TABLE 1

| | | Example | | | | | |
|---|---|---|---|---|---|---|---|
| | Conditional Express | Example 1 | Example 2 | Example 3 | Example 4 | Example 5 | Example 6 |
| (1) | nL1nb > 1.73 | 1.855 | 1.901 | 1.901 | 1.901 | 1.901 | 1.770 |
| (2) | VdL1nb < 35.0 | 25.15 | 27.06 | 27.06 | 27.06 | 27.06 | 29.74 |
| (3) | ΔPgFL1nb < 0.013 | 0.0072 | 0.0076 | 0.0076 | 0.0076 | 0.0076 | 0.0003 |
| (4) | D1/f > 0.08 | 0.165 | 0.175 | 0.207 | 0.124 | 0.165 | 0.169 |
| (5) | 0.4 < f1a/f < 1.7 | 0.86 | 1.64 | 0.78 | 0.85 | 0.93 | 0.87 |
| (6) | 0.3 < R1na/EPD < 1.2 | 0.67 | 0.70 | 0.80 | 0.66 | 0.73 | 0.71 |
| (7) | 1.65 < nL1na < 1.80 | 1.729 | 1.697 | 1.697 | 1.697 | 1.697 | 1.713 |
| (8) | VdL1na > 40 | 54.7 | 55.5 | 55.5 | 55.5 | 55.5 | 53.9 |
| (9) | −1.5 < fGos/fGr < −0.7 | −1.02 | −0.96 | −0.99 | −1.01 | −0.97 | −0.97 |

The description of the above-mentioned examples is a description of examples of the imaging optical system according to the embodiments of the present invention, and the present invention is not limited to the present examples within a range not departing from the gist of the present invention. Various design changes, modifications, combinations, and sub-combinations can be made, and all of these are included in the scope of the present invention.

### DESCRIPTION OF REFERENCE NUMERALS AND SIGNS

G1: first lens group
G2: second lens group
G3: third lens group
1a: group 1a
1b: group 1b
L1na: negative lens L1na
L1nb: negative lens L1nb
Gos: vibration reduction group
Gr: rear group
S: aperture diaphragm
I: image surface

What is claimed is:

1. An imaging optical system comprising, in order from an object side:
a first lens group G1 that has a positive refractive power;
a second lens group G2; and
a third lens group G3, wherein
only the second lens group G2 moves while focusing from an infinite distance object to a close distance object,
the first lens group G1 includes a group 1a and a group 1b in order from the object side,
the group 1b has a negative lens L1na having a meniscus shape that is convex toward the object side and a negative lens L1nb different from the negative lens L1na,
the negative lens L1na is a negative lens positioned closest to the object side in the first lens group G1, and
following conditional expressions are satisfied:
$$nL 1 nb > 1.73 \qquad ( 1 )$$
$$VdL 1 nb < 35 \qquad ( 2 )$$
$$Δ PgFL 1 nb < 0.013 \qquad ( 3 )$$
nL1nb: a refractive index of the negative lens L1nb
VdL1nb: Abbe number of the negative lens L1nb
ΔPgFL1nb: anomalous dispersion of the negative lens L1nb
$$Δ PgFL 1 nb = PgFL 1 nb + 0.0018 \times VdL 1 nb - 0.64833$$
PgFL1nb: a partial dispersion ratio PgF of the negative lens L1nb with respect to a g line and an F line.

2. The imaging optical system according to claim 1, wherein
the group 1a has a positive refractive power and is composed of one or two positive lenses.

3. The imaging optical system according to claim 2, wherein
the first lens group G1 satisfies following conditional expression:
$$D 1 / f > 0.08 \qquad ( 4 )$$
D1: maximum air spacing in the first lens group G1
f: focal length of the entire system at infinity focus.

4. The imaging optical system according to claim 2, wherein
the imaging optical system satisfies following conditional expressions:
$$0.4 < f 1 a / f < 1.7 \qquad ( 5 )$$
$$0.3 < R 1 na / EPD < 1.2 \qquad ( 6 )$$
fla: focal length of the group 1a
f: focal length of entire system at infinity focus
R1na: curvature radius of negative lens L1na on object side
EPD: entrance pupil diameter.

5. The imaging optical system according to claim 1, wherein
the negative lens L1na satisfies following conditional expressions:
$$1.65 < nL 1 na < 1.8 \qquad ( 7 )$$
$$VdL 1 na > 40 \qquad ( 8 )$$
nL1na: refractive index of the negative lens L1na
VdL1na: Abbe number of the negative lens L1na.

6. The imaging optical system according to claim 1, wherein
the third lens group G3 has, in order from the object side, a negative refractive power vibration reduction group Gos that moves in a direction including a component perpendicular to the optical axis while image shake correction, and a positive refractive power rear group Gr, and
following conditional expression is satisfied:
$$- 1.5 < fGos / fGr < - 0.7 \qquad ( 9 )$$
fGos: focal length of the vibration reduction group
fGr: focal length of the rear group.

7. The imaging optical system according to claim 1, wherein
the second lens group G2 is composed of a single lens or one cemented lens.

8. The imaging optical system according to claim 1, wherein
the imaging optical system does not include a diffractive optical element.
